(19) United States
(12) Patent Application Publication
(10) Pub. No.: US 2026/0046918 A1
(43) Pub. Date: Feb. 12, 2026

(54) PRIORITY ADJUSTMENT FOR LOGICAL CHANNELS

(71) Applicant: QUALCOMM Incorporated, San Diego, CA (US)

(72) Inventor: Linhai HE, San Diego, CA (US)

(21) Appl. No.: 19/289,854

(22) Filed: Aug. 4, 2025

Related U.S. Application Data
(60) Provisional application No. 63/680,896, filed on Aug. 8, 2024.

(51) Int. Cl. H04W 72/566; H04W 28/02; H04W 28/06; H04W 72/0453

(52) U.S. Cl. CPC H04W 72/566; H04W 28/0278; H04W 28/06; H04W 72/0453

(57) ABSTRACT

Various aspects of the present disclosure generally relate to wireless communication. In some aspects, a user equipment (UE) may receive a configuration associated with a first logical channel (LCH) with a first priority, wherein the configuration indicates one or more parameters to adjust data assigned to the LCH from the first priority to a second priority. The UE may adjust a priority of a service data unit (SDU) associated with the first LCH to the second priority in accordance with the one or more parameters. The UE may transmit the SDU via uplink shared channel (UL-SCH) resources based at least in part on the second priority. Numerous other aspects are described.

### CROSS-REFERENCE TO RELATED APPLICATION

This Patent Application claims priority to U.S. Provisional Patent Application No. 63/680,896, filed on Aug. 8, 2024, entitled “PRIORITY ADJUSTMENT FOR LOGICAL CHANNELS,” and assigned to the assignee hereof. The disclosure of the prior Application is considered part of and is incorporated by reference into this Patent Application.

### INTRODUCTION

Aspects of the present disclosure generally relate to wireless communication and specifically relate to techniques, apparatuses, and methods associated with logical channels.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various

telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at a user equipment (UE). The apparatus may include one or more memories and one or more processors coupled with the one or more memories. The one or more processors may be configured to cause the UE to receive a configuration associated with a logical channel (LCH) with a first priority, wherein the configuration indicates one or more parameters to adjust data assigned to the LCH from the first priority to a second priority. The one or more processors may be configured to cause the UE to adjust a priority of a service data unit (SDU) associated with the LCH to the second priority in accordance with the one or more parameters. The one or more processors may be configured to cause the UE to transmit the SDU via uplink shared channel (UL-SCH) resources based at least in part on the second priority.

Some aspects described herein relate to an apparatus for wireless communication at a network node. The apparatus may include one or more memories and one or more processors coupled with the one or more memories. The one or more processors may be configured to cause the network node to send a configuration associated with priority adjustment associated with an LCH with a first priority, wherein the configuration indicates one or more parameters to adjust data assigned to the LCH from the first priority to a second priority. The one or more processors may be configured to cause the network node to obtain an SDU via UL-SCH resources in accordance with the second priority.

Some aspects described herein relate to a method of wireless communication performed at a UE. The method may include receiving a configuration associated with an LCH with a first priority, wherein the configuration indicates one or more parameters to adjust data assigned to the LCH from the first priority to a second priority. The method may include adjusting a priority of an SDU associated with the LCH to the second priority in accordance with the one or more parameters. The method may include transmitting the SDU via UL-SCH resources based at least in part on the second priority.

Some aspects described herein relate to a method of wireless communication performed at a network node. The method may include sending a configuration associated with priority adjustment associated with an LCH with a first priority, wherein the configuration indicates one or more parameters to adjust data assigned to the LCH from the first priority to a second priority. The method may include obtaining an SDU via UL-SCH resources in accordance with the second priority.

Some aspects described herein relate to a non-transitory computer-readable medium that stores a set of instructions for wireless communication by a UE. The set of instructions, when executed by one or more processors of the UE, may cause the UE to receive a configuration associated with an LCH with a first priority, wherein the configuration indicates one or more parameters to adjust data assigned to the LCH from the first priority to a second priority. The set of instructions, when executed by one or more processors of the UE, may cause the UE to adjust a priority of an SDU associated with the LCH to the second priority in accordance with the one or more parameters. The set of instructions, when executed by one or more processors of the UE, may cause the UE to transmit the SDU via UL-SCH resources based at least in part on the second priority.

Some aspects described herein relate to a non-transitory computer-readable medium that stores a set of instructions for wireless communication by a network node. The set of instructions, when executed by one or more processors of the network node, may cause the network node to send a configuration associated with priority adjustment associated with an LCH with a first priority, wherein the configuration indicates one or more parameters to adjust data assigned to the LCH from the first priority to a second priority. The set of instructions, when executed by one or more processors of the network node, may cause the network node to obtain an SDU via UL-SCH resources in accordance with the second priority.

Some aspects described herein relate to an apparatus for wireless communication. The apparatus may include means for receiving a configuration associated with an LCH with a first priority, wherein the configuration indicates one or more parameters to adjust data assigned to the LCH from the first priority to a second priority. The apparatus may include means for adjusting a priority of an SDU associated with the LCH to the second priority in accordance with the one or more parameters. The apparatus may include means for transmitting the SDU via UL-SCH resources based at least in part on the second priority.

Some aspects described herein relate to an apparatus for wireless communication. The apparatus may include means for sending a configuration associated with priority adjustment associated with an LCH with a first priority, wherein the configuration indicates one or more parameters to adjust data assigned to the LCH from the first priority to a second priority. The apparatus may include means for obtaining an SDU via UL-SCH resources in accordance with the second priority.

Some aspects described herein relate to an apparatus for wireless communication at a UE. The apparatus may include one or more memories and one or more processors coupled with the one or more memories. The one or more processors may be configured to cause the UE to receive a configuration associated with a first LCH with a first priority, wherein the configuration indicates one or more priority adjustment parameters for data assigned to the first LCH. The one or more processors may be configured to cause the UE to adjust an SDU associated with the first LCH to a second LCH with a second priority in accordance with the one or more priority adjustment parameters. The one or more processors may be configured to cause the UE to transmit the SDU via UL-SCH resources based at least in part on the second priority associated with the second LCH.

Some aspects described herein relate to an apparatus for wireless communication at a network node. The apparatus may include one or more memories and one or more processors coupled with the one or more memories. The one or more processors may be configured to cause the network node to send a configuration associated with priority adjustment associated with a first LCH with a first priority, wherein the configuration indicates one or more priority adjustment parameters for data assigned to the first LCH. The one or more processors may be configured to cause the network node to obtain an SDU via UL-SCH resources in accordance with a second priority associated with a second LCH.

Some aspects described herein relate to a method of wireless communication performed at a UE. The method may include receiving a configuration associated with a first LCH with a first priority, wherein the configuration indicates one or more priority adjustment parameters for data assigned to the first LCH. The method may include adjusting a priority of an SDU associated with the LCH to the second priority in accordance with the one or more parameters. The method may include transmitting the SDU via UL-SCH resources based at least in part on the second priority associated with the second LCH.

Some aspects described herein relate to a method of wireless communication performed at a network node. The method may include sending a configuration associated with priority adjustment associated with a first LCH with a first priority, wherein the configuration indicates one or more priority adjustment parameters for data assigned to the first LCH. The method may include obtaining an SDU via UL-SCH resources in accordance with a second priority associated with a second LCH.

Some aspects described herein relate to a non-transitory computer-readable medium that stores a set of instructions for wireless communication by a UE. The set of instructions, when executed by one or more processors of the UE, may cause the UE to receive a configuration associated with a first LCH with a first priority, wherein the configuration indicates one or more priority adjustment parameters for data assigned to the first LCH. The set of instructions, when executed by one or more processors of the UE, may cause the UE to adjust an SDU associated with the first LCH to a second LCH with a second priority in accordance with the one or more priority adjustment parameters. The set of instructions, when executed by one or more processors of the UE, may cause the UE to transmit the SDU via UL-SCH resources based at least in part on the second priority associated with the second LCH.

Some aspects described herein relate to a non-transitory computer-readable medium that stores a set of instructions for wireless communication by a network node. The set of instructions, when executed by one or more processors of the network node, may cause the network node to send a configuration associated with priority adjustment associated with a first LCH with a first priority, wherein the configuration indicates one or more priority adjustment parameters for data assigned to the first LCH. The set of instructions, when executed by one or more processors of the network node, may cause the network node to obtain an SDU via UL-SCH resources in accordance with a second priority associated with a second LCH.

Some aspects described herein relate to an apparatus for wireless communication. The apparatus may include means for receiving a configuration associated with a first LCH with a first priority, wherein the configuration indicates one or more priority adjustment parameters for data assigned to the first LCH. The apparatus may include means for adjusting an SDU associated with the first LCH to a second LCH with a second priority in accordance with the one or more priority adjustment parameters. The apparatus may include means for transmitting the SDU via UL-SCH resources based at least in part on the second priority associated with the second LCH.

Some aspects described herein relate to an apparatus for wireless communication. The apparatus may include means for sending a configuration associated with priority adjustment associated with a first LCH with a first priority, wherein the configuration indicates one or more priority adjustment parameters for data assigned to the first LCH. The apparatus may include means for obtaining an SDU via UL-SCH resources in accordance with a second priority associated with a second LCH.

Some aspects described herein relate to an apparatus for wireless communication at a UE. The apparatus may include one or more memories and one or more processors coupled with the one or more memories. The one or more processors may be configured to cause the UE to receive a configuration associated with a first LCH having a first priority. The one or more processors may be configured to cause the UE to adjust an SDU associated with the first LCH to a second LCH having a second priority according to the configuration associated with the first LCH. The one or more processors may be configured to cause the UE to transmit the SDU via UL-SCH resources based at least in part on the second priority associated with the second LCH.

Some aspects described herein relate to an apparatus for wireless communication at a network node. The apparatus may include one or more memories and one or more processors coupled with the one or more memories. The one or more processors may be configured to cause the network node to send a configuration associated with priority adjustment associated with a first LCH having a first priority. The one or more processors may be configured to cause the network node to obtain an SDU via UL-SCH resources in accordance with a second priority associated with a second LCH.

Some aspects described herein relate to a method of wireless communication performed at a UE. The method may include receiving a configuration associated with a first LCH having a first priority. The method may include adjusting an SDU associated with the first LCH to a second LCH having a second priority according to the configuration associated with the first LCH. The method may include transmitting the SDU via UL-SCH resources based at least in part on the second priority associated with the second LCH.

Some aspects described herein relate to a method of wireless communication performed at a network node. The method may include sending a configuration associated with priority adjustment associated with a first LCH having a first priority. The method may include obtaining an SDU via UL-SCH resources in accordance with a second priority associated with a second LCH.

Some aspects described herein relate to a non-transitory computer-readable medium that stores a set of instructions for wireless communication by a UE. The set of instructions, when executed by one or more processors of the UE, may cause the UE to receive a configuration associated with a first LCH having a first priority. The set of instructions, when executed by one or more processors of the UE, may cause the UE to adjust an SDU associated with the first LCH to a second LCH having a second priority according to the configuration associated with the first LCH. The set of instructions, when executed by one or more processors of the UE, may cause the UE to transmit the SDU via UL-SCH resources based at least in part on the second priority associated with the second LCH.

Some aspects described herein relate to a non-transitory computer-readable medium that stores a set of instructions for wireless communication by a network node. The set of instructions, when executed by one or more processors of the network node, may cause the network node to send a configuration associated with priority adjustment associated with a first LCH having a first priority. The set of instructions, when executed by one or more processors of the network node, may cause the network node to obtain an SDU via UL-SCH resources in accordance with a second priority associated with a second LCH.

Some aspects described herein relate to an apparatus for wireless communication. The apparatus may include means for receiving a configuration associated with a first LCH having a first priority. The apparatus may include means for adjusting an SDU associated with the first LCH to a second LCH having a second priority according to the configuration associated with the first LCH. The apparatus may include means for transmitting the SDU via UL-SCH resources based at least in part on the second priority associated with the second LCH.

Some aspects described herein relate to an apparatus for wireless communication. The apparatus may include means for sending a configuration associated with priority adjustment associated with a first LCH having a first priority. The apparatus may include means for obtaining an SDU via UL-SCH resources in accordance with a second priority associated with a second LCH.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example disaggregated base station architecture.

FIG. 4 is a diagram illustrating examples of extended reality (XR) traffic.

FIG. 5 is a diagram illustrating an example of a user plane protocol stack and a control plane protocol stack for a network node and a core network in communication with a UE.

FIG. 6 is a diagram illustrating an example of a mapping among uplink logical channels (LCHs), transport channels, and physical channels.

FIGS. 7A-7B are diagrams illustrating examples associated with priority adjustment for LCHs.

FIG. 8 is a flowchart illustrating an example process performed, for example, by a UE.

FIG. 9 is a flowchart illustrating an example process performed, for example, by a network node.

FIG. 10 is a flowchart illustrating an example process performed, for example, by a UE.

FIG. 11 is a flowchart illustrating an example process performed, for example, by a network node.

FIG. 12 is a diagram of an example apparatus for wireless communication.

FIG. 13 is a diagram illustrating an example of a hardware implementation for an apparatus employing a processing system.

FIG. 14 is a diagram illustrating an example of an implementation of code and circuitry for an apparatus.

FIG. 15 is a diagram of an example apparatus for wireless communication.

FIG. 16 is a diagram illustrating an example of a hardware implementation for an apparatus employing a processing system.

FIG. 17 is a diagram illustrating an example of an implementation of code and circuitry for an apparatus.

### DETAILED DESCRIPTION

In a wireless network, a user equipment (UE) and a network node may each implement one or more protocol stacks (e.g., a user plane protocol stack and a control plane protocol stack) that include various protocol layers, such as a physical (PHY) layer, a medium access control (MAC) layer, and a radio link control (RLC) layer, among other examples. Information flows between different protocol layers, known as channels, may be used to segregate and transport different data types across different layers. Accordingly, the channels may provide interfaces between layers within the one or more protocol stacks and enable an orderly and defined data segmentation. For example, logical channels (LCHs) carry user data and signaling messages between the RLC layer and the MAC layer, transport channels carry user data and signaling messages between the MAC layer and the PHY layer, and physical channels carry user data and signaling messages between the UE and the network node. For example, in an uplink direction, uplink LCHs include a common control channel (CCCH) used to carry control information for multiple UEs, a dedicated control channel (DCCH) dedicated to carrying control information for a particular UE, and a dedicated traffic channel (DTCH) dedicated to carrying traffic for a particular UE, and uplink transport channels include an uplink shared channel (UL-SCH) that is used to carry uplink data and shared among the CCCH, DCCH, DTCH. Accordingly, in the uplink direction, the MAC layer performs an LCH prioritization procedure to control the manner in which UL-SCH resources are shared among different LCHs.

For example, when a UE is configured with multiple LCHs that share UL-SCH resources, a MAC layer at the UE may prioritize data from the LCHs according to respective LCH configurations that a network node sends or otherwise provides for the multiple LCHs. For example, the LCH configurations may be provided in one or more radio resource control (RRC) messages, where the parameters associated with each LCH configuration may include a priority (e.g., an integer from 1 to 16 or another suitable value, where I corresponds to a highest priority and 16 corresponds to a lowest priority), a prioritized bit rate (PBR) (e.g., a value in kilobytes per second (kBps)), and a bucket size duration (BSD) (e.g., a value in milliseconds). The PBR and the BSD associated with an LCH may parameterize a leaky bucket regulator associated with the LCH, which the MAC layer may use together with the configured priorities to schedule data associated with different LCHs according to a fair priority queuing policy. For example, each LCH is associated with a scheduling eligibility state variable, Bj, which is initialized to zero when the LCH is established. The state variable associated with each LCH is periodically updated (e.g., prior to each LCH prioritization) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE initially identifies one or more eligible LCHs (e.g., LCHs that have uplink data and Bj value greater than 0), and starts scheduling data from eligible LCHs according to a descending priority (e.g., from a highest priority to a lowest priority). For example, when scheduling data from an eligible LCH, the selected LCH is allocated enough resources to achieve the PBR associated with the LCH (e.g., a transmit buffer associated with the LCH is emptied by at least the value of Bj), and the state variable Bj for the LCH is then updated by subtracting the size of the scheduled data. If the selected LCH has a PBR with an infinite value, the transmit buffer associated with the LCH is emptied completely before serving any other LCH. In cases where the uplink grant has spare radio resources remaining after all eligible LCHs with a Bj value greater than 0 have been scheduled, the UE then schedules data from all LCHs according to a strict priority without regard to the Bj value (e.g., not limited to eligible LCHs only). In this way, the LCH prioritization may maximize throughput and provide relative delay performance across various LCHs that share UL-SCH resources.

However, although the LCH prioritization provides acceptable performance for clastic traffic that does not have hard delay requirements, the LCH prioritization procedure poses challenges for delay-sensitive traffic that tends to arrive in bursts, such as extended reality (XR) traffic. For example, uplink traffic bursts may cause scheduling starvation in LCHs with a relatively low priority (e.g., uplink grants may allocate insufficient radio resources to serve the low-priority LCHs) unless the LCHs with the relatively low priority are allocated sufficient bandwidth (e.g., provisioned according to a worst case scenario), which is inefficient.

Various aspects described herein generally relate to priority adjustment for uplink LCHs, such that a priority can be adjusted (e.g., upgraded or otherwise increased) for delay-critical data associated with an LCH. For example, in some aspects, an LCH configuration associated with an LCH may include one or more parameters related to priority adjustment, in addition to the priority, PBR, BSD, and other parameters associated with the LCH. For example, in some aspects, the parameters related to priority adjustment may indicate whether the LCH is allowed to dynamically adjust the LCH associated with the buffered data (e.g., assign some buffered data to a different LCH with a higher priority, as an LCH and a priority are generally equivalent in an LCH prioritization procedure because an LCH and a priority typically have a one-to-one relationship). Furthermore, in some aspects, the parameters related to priority adjustment may indicate a threshold on a remaining time associated with the buffered data (e.g., a residual value of a packet data convergence protocol (PDCP) discard timer), where any buffered data with a remaining time that satisfies (e.g., is less than) the threshold may be considered delay-sensitive. In cases where the LCH is allowed to dynamically adjust the LCH associated with delay-sensitive data, the LCH configuration may further indicate a target LCH to which the delay-sensitive data may be adjusted, and/or may indicate one or more restrictions on how many times and/or how much data can be adjusted to a different LCH.

Accordingly, when a service data unit (SDU) associated with a current LCH has a remaining time that satisfies (e.g., is below) the threshold, and any adjustment limits configured for the current LCH have not been reached, the UE may adjust the SDU from the current LCH to the target LCH indicated in the LCH configuration associated with the current LCH. After the SDU has been adjusted to the target LCH, the SDU may be subject to any LCH prioritization restrictions (e.g., one or more conditions that determine whether an LCH can be served using an uplink grant, such as the Bj value) associated with the new LCH. When an SDU adjusted to a different LCH is scheduled or otherwise multiplexed within a transport block (TB), the Bj value associated with an original LCH associated with the SDU may be updated. Furthermore, in cases where the SDU is adjusted from a current LCH to a target LCH and an adjustment limit is configured for the current LCH, the SDU adjustment is counted toward the adjustment limit configured for the current LCH. In addition, a buffer status report (BSR) may be triggered in cases where the SDU is adjusted to a target LCH with a higher priority than any other LCHs with buffered data. In some aspects, if the BSR triggered by the LCH adjustment triggers a scheduling request (SR), the SR is associated with an SR configuration for the adjusted LCH.

In this way, by adjusting an SDU with delay-sensitive data to a different LCH with a higher priority, the described techniques can be used to avoid scheduling starvation in LCHs that have a relatively low priority. Furthermore, by adjusting an SDU with delay-sensitive data to a different LCH with a higher priority, the described techniques can be used to schedule uplink traffic that may be about to expire (e.g., prior to a PDCP discard timer expiring), which improves uplink performance. Furthermore, by establishing limits on how often and/or how much delay-sensitive data can be adjusted to a different LCH, the described techniques can prevent or mitigate scenarios where LCH adjustments may delay scheduling buffered uplink data in LCHs with a high priority. In this way, some aspects described herein may schedule uplink traffic in a manner that can satisfy delay-sensitive requirements while also ensuring that shared uplink resources are fairly allocated among LCHs with different priorities.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IOT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient loT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

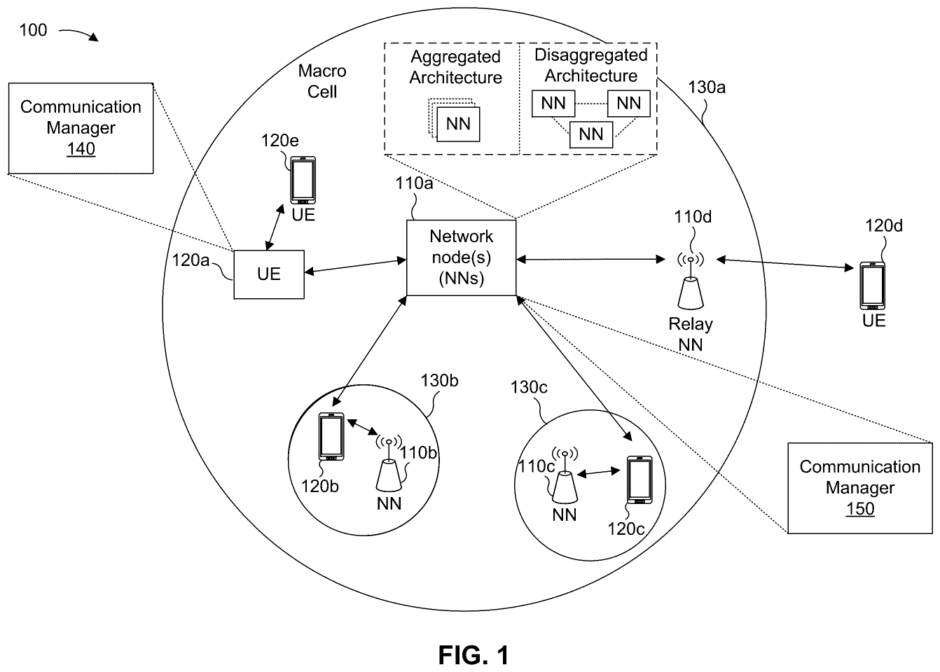

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FRI is greater than 6 GHZ, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, PDCP functions, and/or service data adaptation protocol (SDAP) functions, among other examples. A DU may host one or more of an RLC layer, a MAC layer, and/or one or more higher PHY layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic arca (for example, several kilometers in radius) and may allow unrestricted access by UEs 120 with service subscriptions. A pico cell may cover a relatively small geographic arca and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IOT (narrowband IoT) devices. An IoT UE or NB-IOT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120c in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a configuration associated with an LCH with a first priority, wherein the configuration indicates one or more parameters to adjust data assigned to the LCH from the first priority to a second priority; adjust a priority of an SDU associated with the LCH to the second priority in accordance with the one or more parameters; and transmit the SDU via UL-SCH resources based at least in part on the second priority. Additionally, or alternatively, the communication manager 140 may receive a configuration associated with a first LCH with a first priority, wherein the configuration indicates one or more priority adjustment parameters for data assigned to the first LCH; adjust an SDU associated with the first LCH to a second LCH with a second priority in accordance with the one or more priority adjustment parameters; and transmit the SDU via UL-SCH resources based at least in part on the second priority associated with the second LCH. Additionally, or alternatively, the communication manager 140 may perform one or more other operations described herein.

In some aspects, the network node 110 may include a communication manager 150. As described in more detail elsewhere herein, the communication manager 150 may send a configuration associated with priority adjustment associated with an LCH with a first priority, wherein the configuration indicates one or more parameters to adjust data assigned to the LCH from the first priority to a second priority; and obtain an SDU via UL-SCH resources in accordance with the second priority. Additionally, or alternatively, the communication manager 150 may send a configuration associated with priority adjustment associated with a first LCH with a first priority, wherein the configuration indicates one or more priority adjustment parameters for data assigned to the first LCH; and obtain an SDU via UL-SCH resources in accordance with a second priority associated with a second LCH. Additionally, or alternatively, the communication manager 150 may perform one or more other operations described herein.

As indicated above, FIG. 1 is provided as an example. Other examples may differ from what is described with regard to FIG. 1.

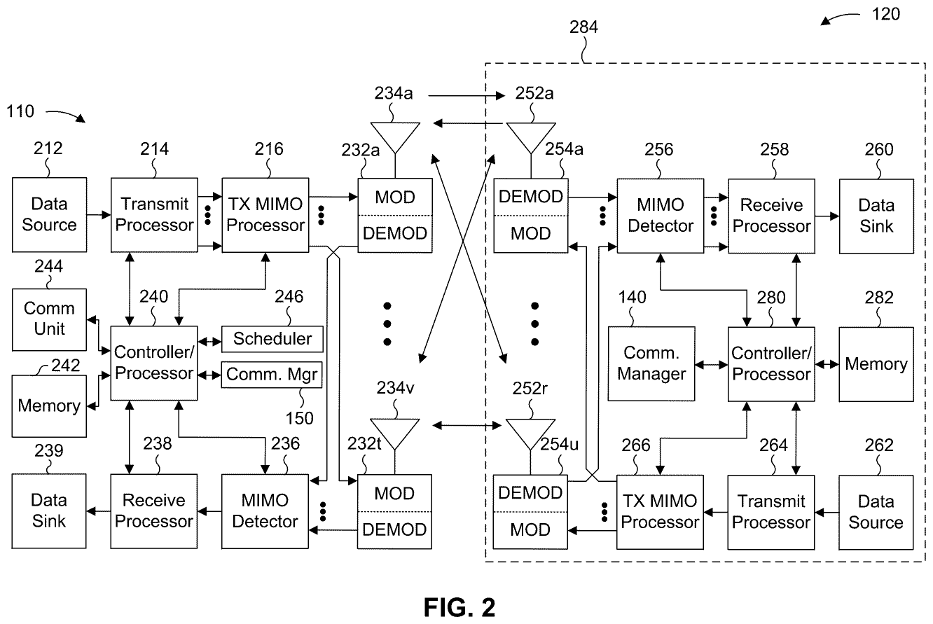

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more TBs of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (RX) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

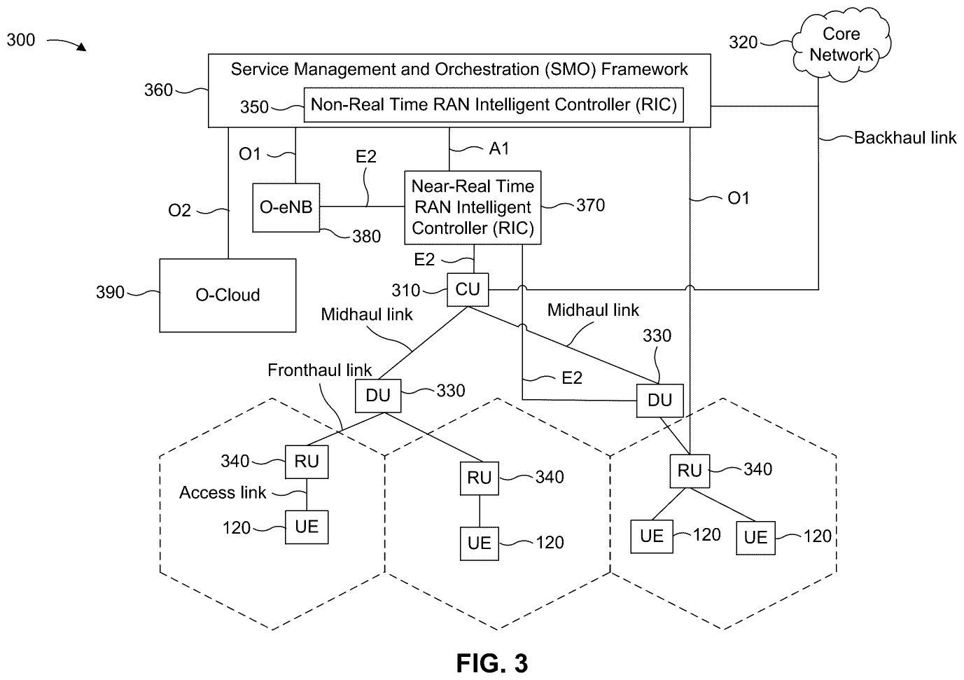

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an Al interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-CNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

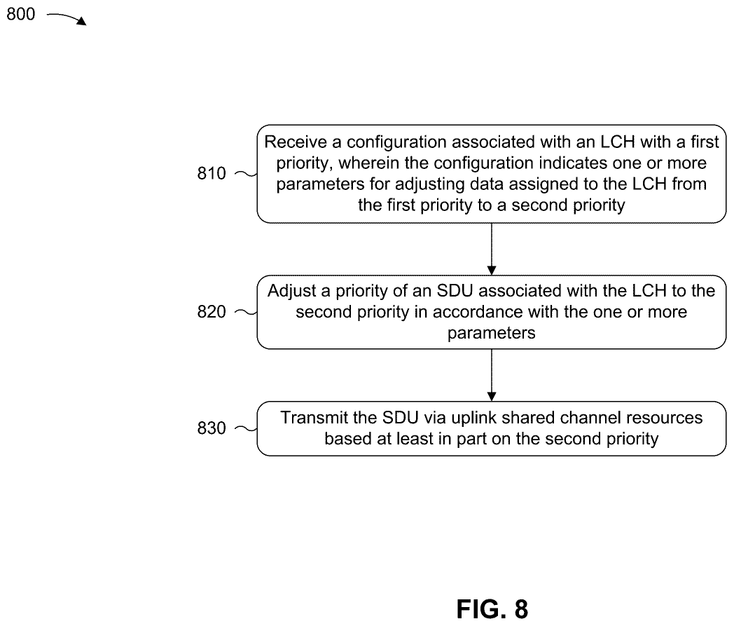

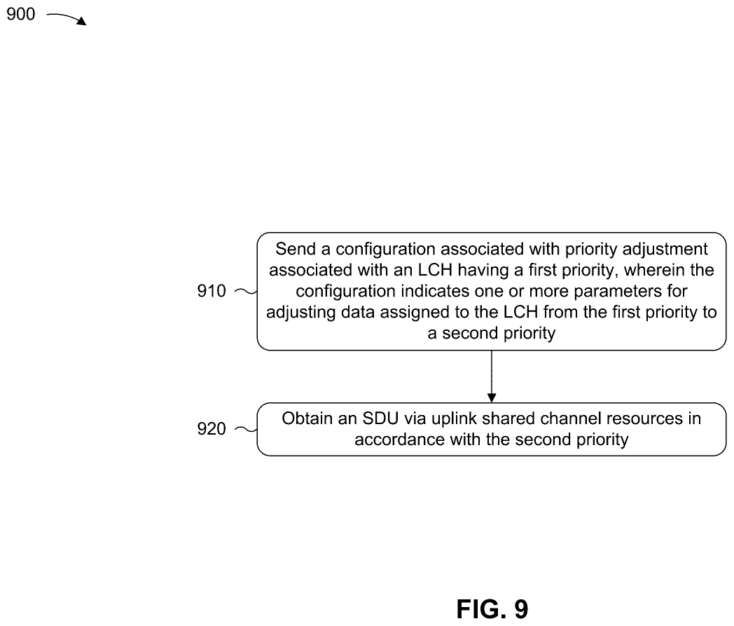

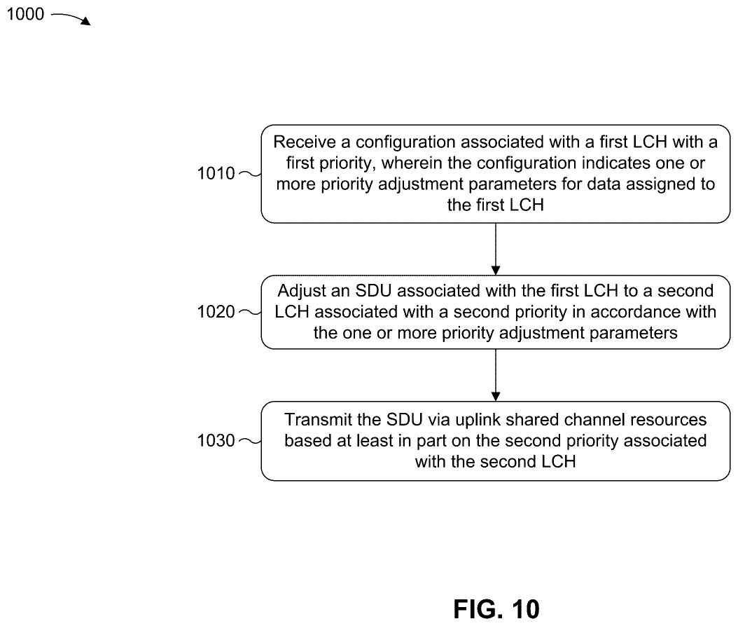

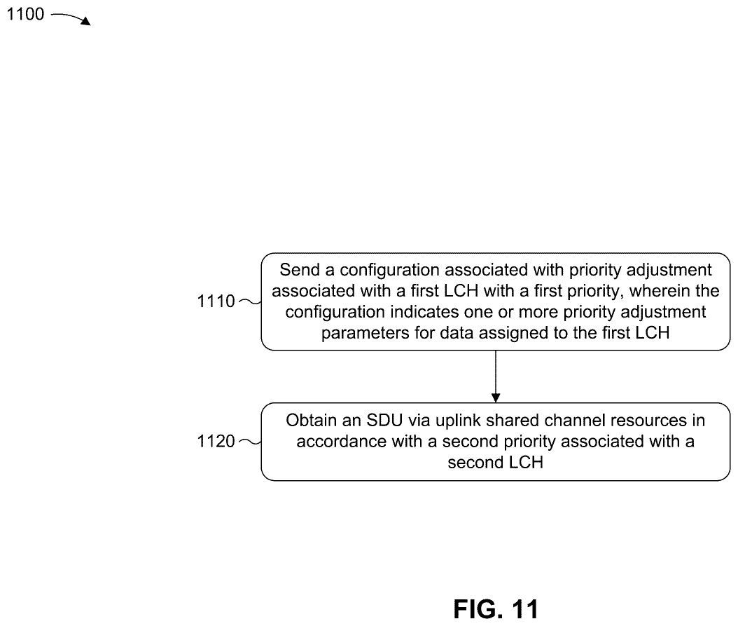

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with priority adjustment for LCHs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for receiving a configuration associated with an LCH with a first priority, wherein the configuration indicates one or more parameters to adjust data assigned to the LCH from the first priority to a second priority; means for adjusting a priority of an SDU associated with the LCH to the second priority in accordance with the one or more parameters; and/or means for transmitting the SDU via UL-SCH resources based at least in part on the second priority. In some aspects, the UE 120 includes means for receiving a configuration associated with a first LCH with a first priority, wherein the configuration indicates one or more priority adjustment parameters for data assigned to the first LCH; means for adjusting an SDU associated with the first LCH to a second LCH with a second priority in accordance with the one or more priority adjustment parameters; and/or means for transmitting the SDU via UL-SCH resources based at least in part on the second priority associated with the second LCH. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for sending a configuration associated with priority adjustment associated with an LCH with a first priority, wherein the configuration indicates one or more parameters to adjust data assigned to the LCH from the first priority to a second priority; and/or means for obtaining an SDU via UL-SCH resources in accordance with the second priority. In some aspects, the network node 110 includes means for sending a configuration associated with priority adjustment associated with a first LCH with a first priority, wherein the configuration indicates one or more priority adjustment parameters for data assigned to the first LCH; and/or means for obtaining an SDU via UL-SCH resources in accordance with a second priority associated with a second LCH. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

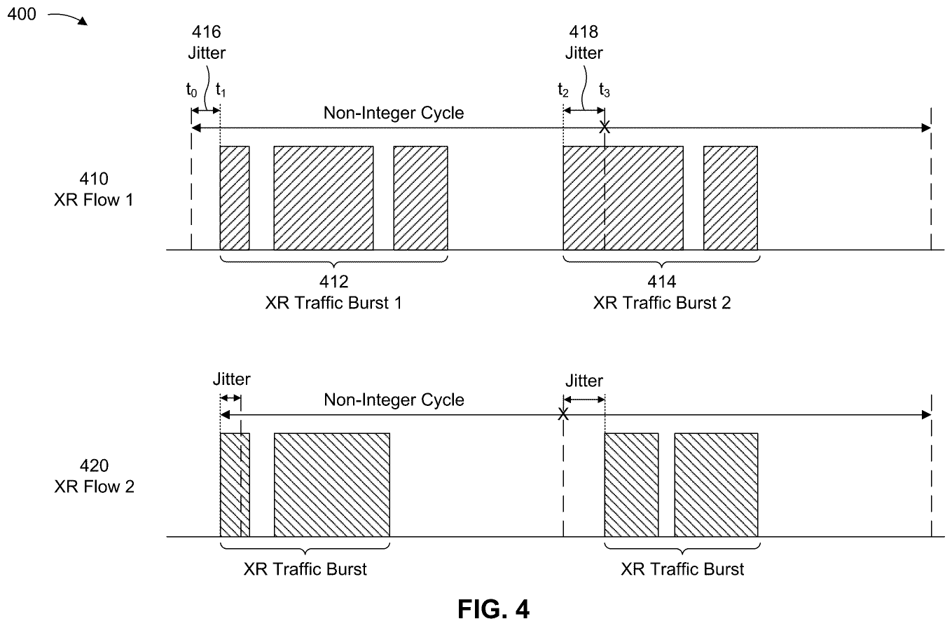

FIG. 4 is a diagram illustrating examples 400 of XR traffic. As described herein, XR traffic may generally refer to wireless communications for technologies such as VR, MR, and/or AR. VR may refer to technologies in which a user is immersed in a simulated experience that is similar or different from the real world. A user may interact with a VR system through a VR headset or a multi-projected environment that generates realistic images, sounds, and other sensations that simulate physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may include downlink traffic that is transmitted by a network node 110 and received by a UE 120 and/or uplink traffic that may be transmitted by a UE 120 and received by a network node 110.

XR traffic may arrive in periodic traffic bursts (“XR traffic bursts”). For example, XR traffic may include pose, video, and/or other data transmitted by and/or to an XR-enabled UE 120, may have a varying video frame size over time, and/or may have quasi-periodic packet arrival times with application jitter (e.g., variations in delays and/or arrival times for XR traffic). Furthermore, traffic arrival time at a network node 110 (e.g., a RAN node) is periodic with non-negligible jitter due to uncertain application processing times. Video frame sizes are an order of magnitude larger than packets in voice or industrial control communications, in addition to not being fixed over time. Rather, segmentation of each frame is expected, which implies that packets arrive in bursts that must be handled together to meet stringent bounded latency requirements. XR traffic bursts may vary with respect to the number of packets per traffic burst and/or with respect to a size of each packet in a traffic burst.

For example, FIG. 4 illustrates a first XR flow 410 that includes a first XR traffic burst 412 and a second XR traffic burst 414. As shown in FIG. 4, the XR traffic bursts may include different numbers of packets (e.g., the first XR traffic burst 412 is shown with three packets, represented as rectangles, and the second XR traffic burst 414 is shown with two packets). Furthermore, as illustrated in FIG. 4, the three packets in the first XR traffic burst 412 and the two packets in the second XR traffic burst 414 may vary in size. For example, packets within the first XR traffic burst 412 and packets within the second XR traffic burst 414 may include varying amounts of data. XR traffic bursts may arrive at non-integer periods (e.g., in a non-integer cycle). The periods may be different than an integer number of symbols, slots, or other transmission time intervals (TTIs). In an example, for 60 frames per second (FPS) video data, XR traffic bursts may arrive in 1/60=16.67 ms periods. In another example, for 120 FPS video data, XR traffic bursts may arrive in 1/120=8.33 ms periods. Arrival times of XR traffic may vary. For example, XR traffic bursts may arrive at a transmitter (e.g., a UE 120 or a network node 110) and become available for transmission at a time that is carlier or later than a time at which the transmitter expects the XR traffic bursts. As described herein, the variability of the packet arrival relative to the period (e.g., 16.76 ms period, 8.33 ms period, or the like) may be referred to as jitter. In an example, jitter for XR traffic may range from −4 ms (e.g., an earlier than expected arrival) to +4 ms (e.g., a later than expected arrival). For instance, referring to the first XR flow 410, a transmitter may expect a first packet of the first XR traffic burst 412 to arrive at time to, but the first packet of the first XR traffic burst 412 actually arrives at time t₁ (e.g., later than the expected arrival time), where a jitter 416 for the first XR traffic burst 412 corresponds to a difference between the expected arrival time and the actual arrival time. Similarly, for the second XR flow 414, the transmitter may expect a first packet of the second XR traffic burst 414 to arrive at time t₃, but the first packet of the second XR traffic burst 414 actually arrives at time t₂ (e.g., before the expected arrival time), where a jitter 418 for the second XR traffic burst 414 corresponds to a difference between the expected and actual arrival time.

XR traffic may include multiple flows that arrive at a transmitter concurrently with one another (or within a threshold period of time). For instance, the second XR flow 420 shown in FIG. 4 may have different characteristics than the first XR flow 410. For instance, the second XR flow 420 may have XR traffic bursts with different numbers of packets, different sizes of packets, different jitters, or other characteristics that vary from the first XR flow 410. In an example, the first XR flow 410 may include video data associated with an XR application and the second XR flow 420 may include audio data that corresponds to the video data associated with the XR application. In another example, the first XR flow 410 may include intra-coded picture frames (I-frames) that include complete images, and the second XR flow 420 may include predicted picture frames (P-frames) that include changes from a previous image.

XR traffic may have an associated packet delay budget (PDB). If a packet does not arrive within the PDB, a transmitter may discard the packet. In an example, if a packet corresponding to a video frame of a video does not arrive at a transmitter within a PDB, the transmitter may discard the packet, as the video has advanced beyond the frame. In general, XR traffic may be characterized by relatively high data rates and low latency requirements. The latency in XR traffic may affect a user experience (e.g., a QoE). For instance, XR traffic may have applications in enhanced mobile broadband (eMBB) and ultra-reliable low-latency communication (URLLC) services. Some wireless communication systems may employ dynamic grants for scheduling purposes to accommodate delay-sensitive traffic (e.g., XR traffic). In a dynamic grant, a scheduler (e.g., a network node 110) may use control signaling to allocate resources for transmission or reception at a UE 120 (e.g., a grant of uplink or downlink resources). Dynamic grants may be flexible and can adapt to variations in traffic behavior (e.g., based on delay status reporting and/or statistical delay reporting provided by a UE 120).

As indicated above, FIG. 4 is provided as an example. Other examples may differ from what is described with regard to FIG. 4.

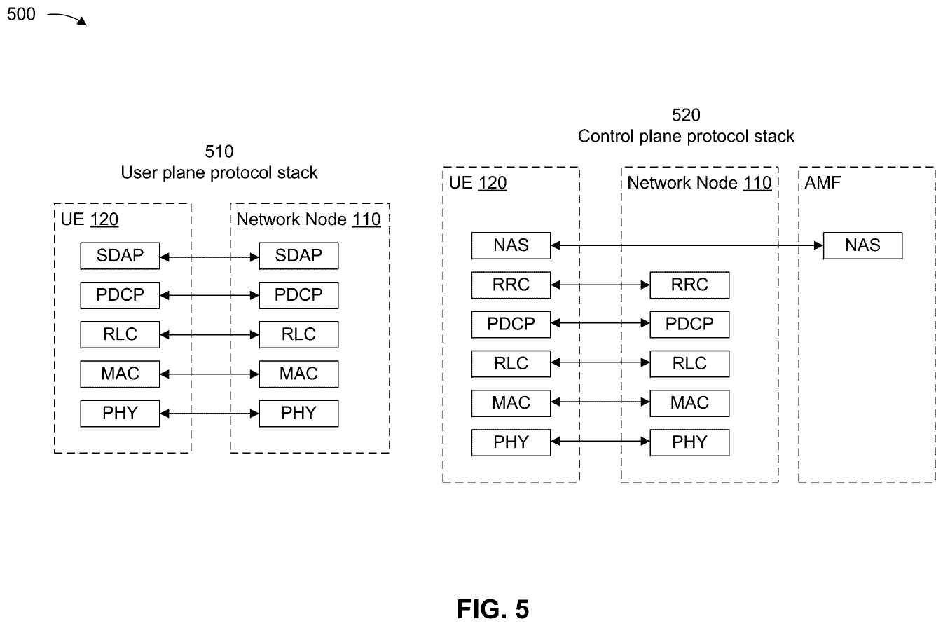

FIG. 5 is a diagram illustrating an example 500 of a user plane protocol stack 510 and a control plane protocol stack 520 for a network node 110 and a core network in communication with a UE 120. In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

In the user plane protocol stack 510, the UE 120 and the network node 110 may include respective PHY layers, MAC layers, RLC layers, PDCP layers, and SDAP layers. A user plane function (UPF) may handle transport of user data between the UE 120 and the network node 110. In the control plane protocol stack 520, the UE 120 and the network node 110 may include respective RRC layers. Furthermore, the UE 120 may include a non-access stratum (NAS) layer in communication with an NAS layer of an AMF. The AMF may be associated with a core network associated with the network node 110, such as a 5G core network (5GC) or a next-generation radio access network (NG-RAN). A control plane function may handle transport of control information between the UE 120 and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 5, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE 120 and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a Qos parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP SDUs, ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from TBs delivered to/from the PHY layer on transport channels, scheduling information reporting, error correction through hybrid ARQ (HARQ), priority handling between UEs 120 by dynamic scheduling, priority handling between LCHs of one UE 120 by LCH prioritization, and padding.

The MAC layer may package data from LCHs into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to LCHs and may provide data to the RLC layer via the LCHs. The RLC layer may map the LCHs to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 5 is provided as an example. Other examples may differ from what is described with regard to FIG. 5.

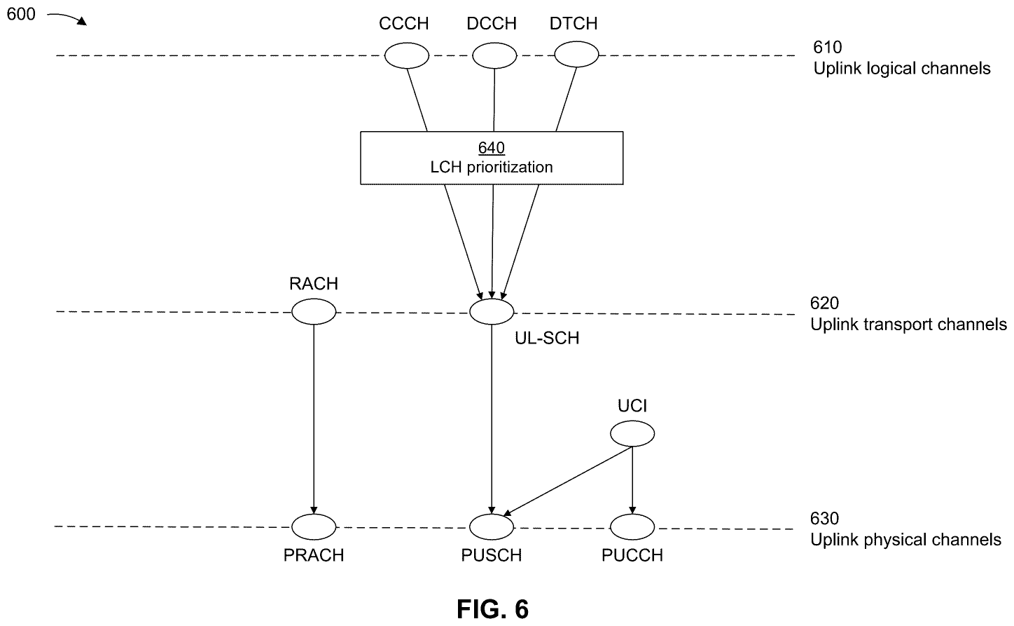

FIG. 6 is a diagram illustrating an example 600 of a mapping among uplink LCHs 610, uplink transport channels 620, and uplink physical channels 630. The uplink LCHs 610, the uplink transport channels 620, and the uplink physical channels 630 are implemented in a UE 120.

For example, as described herein, a UE 120 and a network node 110 may each implement one or more protocol stacks (e.g., a user plane protocol stack and a control plane protocol stack) that include various protocol layers, such as a PHY layer, a MAC layer, and an RLC layer, among other examples. Information flows between different protocol layers, known as channels, are used to segregate and transport different data types across different layers. Accordingly, the channels may provide interfaces between layers within the one or more protocol stacks and enable an orderly and defined data segmentation. For example, LCHs carry user data and signaling messages between the RLC layer and the MAC layer, transport channels carry user data and signaling messages between the MAC layer and the PHY layer, and physical channels carry user data and signaling messages between the UE 120 and the network node 110.

For example, as shown in FIG. 6, uplink LCHs 610 include a CCCH used to carry control information for multiple UEs 120, a dedicated DCCH dedicated to carrying control information for a particular UE 120, and a DTCH dedicated to carrying traffic for a particular UE 120. As further shown in FIG. 6, uplink transport channels 620 include an UL-SCH that is used to carry uplink data and a random access channel (RACH) used for a RACH procedure. As further shown in FIG. 6, the UL-SCH is shared among the CCCH, DCCH, DTCH. Furthermore, as further shown in FIG. 6, uplink physical channels 630 include a PRACH that is mapped to the RACH transport channel and serves as the physical channel through which a UE 120 initiates and/or synchronizes communication with a network node 110, a PUSCH that is mapped to the UL-SCH transport channel and used to carry uplink data from a UE 120 to a network node 110, and a PUCCH used to carry UCI or other control signaling (e.g., acknowledgements or negative acknowledgements for received data, BSRs, SRs, and/or CQI information, among other examples) from a UE 120 to a network node 110. In addition, as shown in FIG. 6, the PUSCH may carry UCI in some cases (e.g., UCI may be multiplexed with uplink user data in a PUSCH transmission).

As described herein, the UL-SCH is shared among the CCCH, DCCH, DTCH, whereby a MAC layer may perform an LCH prioritization procedure 640 in the uplink direction to control how UL-SCH resources are shared among different LCHs. For example, when a UE 120 is configured with multiple LCHs 610 that share UL-SCH resources, the MAC layer at the UE 120 may prioritize data from the LCHs 610 according to respective LCH configurations that a network node 110 sends or otherwise provides for the multiple LCHs 610. For example, the LCH configurations may be provided in one or more RRC messages, where the parameters associated with each LCH configuration may include a priority (e.g., an integer from 1 to 16 or another suitable value, where 1 corresponds to a highest priority and 16 corresponds to a lowest priority), a PBR (e.g., a value in kBps), and a BSD (e.g., a value in milliseconds). The PBR and the BSD associated with an LCH 610 may parameterize a leaky bucket regulator associated with the LCH 610, which the MAC layer uses together with the configured priorities to schedule data associated with different LCHs 610 according to a fair priority queuing policy. For example, each LCH 610 is associated with a state variable, Bj, that relates to scheduling eligibility, where the state variable Bj is initialized to zero when an LCH 610 is established. The state variable associated with each LCH 610 is periodically updated (e.g., prior to each execution of the LCH prioritization procedure 640) according to Bj=Bj+PBR×T, where T is a duration or time period since the value of Bj was most recently updated. If Bj has a value that exceeds a bucket size defined as PBR×BSD, the value of Bj is rounded down to the bucket size value.

Accordingly, when an uplink grant is available, the UE 120 initially identifies one or more eligible LCHs 610 (e.g., LCHs 610 that have uplink data and Bj value greater than 0), and starts scheduling data from eligible LCHs 610 according to a descending priority (e.g., from a highest priority to a lowest priority). For example, when scheduling data from an eligible LCH 610, the selected LCH 610 is allocated enough resources to achieve the PBR associated with the LCH 610 (e.g., a transmit buffer associated with the LCH 610 is emptied by at least the value of Bj), and the state variable Bj for the LCH 610 is then updated by subtracting the size of the scheduled data. If the selected LCH 610 has a PBR with an infinite value, the transmit buffer associated with the LCH 610 is emptied completely before serving any other LCH 610. In cases where the uplink grant has spare radio resources remaining after all eligible LCHs 610 have been scheduled, the UE 120 then schedules data from all LCHs 610 according to a strict priority without regard to the Bj value (e.g., not limited to eligible LCHs 610). In this way, the LCH prioritization procedure 640 may maximize throughput and provide relative delay performance across various LCHs 610.

However, although the LCH prioritization procedure 640 may provide acceptable performance for elastic traffic that does not have hard delay requirements, the LCH prioritization procedure 640 poses challenges for delay-sensitive traffic that tends to arrive in bursts, such as XR traffic. For example, uplink traffic bursts may cause scheduling starvation in LCHs 610 with a relatively low priority (e.g., uplink grants may allocate insufficient radio resources to serve the low-priority LCHs 610) unless the LCHs 610 with the relatively low priority are allocated sufficient bandwidth (e.g., provisioned according to a worst case scenario), which is inefficient.

Various aspects described herein generally relate to priority adjustment for uplink LCHs 610, such that a priority can be adjusted (e.g., upgraded or otherwise increased) for delay-critical data associated with an LCH 610. For example, in some aspects, an LCH configuration associated with an LCH 610 may include one or more parameters related to priority adjustment, in addition to the priority, PBR, BSD, and other parameters associated with the LCH 610. For example, in some aspects, the parameters related to priority adjustment may indicate whether the LCH 610 is allowed to dynamically adjust the LCH 610 associated with the buffered data associated with the LCH 610 (e.g., assign some data to a different LCH 610 with a higher priority, as an LCH 610 and a priority are equivalent in the LCH prioritization procedure 640). Furthermore, in some aspects, the parameters related to priority adjustment may indicate a threshold on a remaining time associated with buffered data (e.g., a residual value of a PDCP discard timer), where any buffered data with a remaining time that satisfies (e.g., is less than) the threshold may be considered delay-sensitive. In cases where the LCH 610 is allowed to dynamically adjust the LCH 610 associated with delay-sensitive data, the LCH configuration may further indicate a target LCH 610 to which the delay-sensitive data may be adjusted, and/or may indicate one or more restrictions on how many times and/or how much data can be adjusted to a different LCH 610.

Accordingly, when an SDU associated with a current LCH 610 has a remaining time that satisfies (e.g., is below) the threshold, and any adjustment limits configured for the current LCH 610 have not been reached, the UE 120 may adjust the SDU from the current LCH 610 to the target LCH 610 indicated in the LCH configuration associated with the current LCH 610. After the SDU has been adjusted to the target LCH 610, the SDU may be subject to any LCH prioritization restrictions (e.g., one or more conditions that determine whether an LCH 610 can be served using an uplink grant, such as the Bj value) associated with the new LCH 610. When an SDU adjusted to a different LCH 610 is scheduled or otherwise multiplexed within a TB, the Bj value associated with an original LCH 610 associated with the SDU may be updated. Furthermore, in cases where the SDU is adjusted from a current LCH 610 to a target LCH 610 and an adjustment limit is configured for the current LCH 610, the SDU adjustment is counted toward the adjustment limit configured for the current LCH 610. In addition, a BSR may be triggered in cases where the SDU is adjusted to a target LCH 610 with a higher priority than any other LCHs 610 with buffered data. In some aspects, if the BSR triggered by the LCH adjustment triggers an SR, the SR is associated with an SR configuration for the adjusted LCH 610.

In this way, by adjusting an SDU with delay-sensitive data to a different LCH 610 with a higher priority, some aspects described herein can be used to avoid scheduling starvation in LCHs 610 that have a relatively low priority. Furthermore, by adjusting an SDU with delay-sensitive data to a different LCH 610 with a higher priority, some aspects described herein can be used to schedule uplink traffic that may be about to expire (e.g., prior to a PDCP discard timer expiring), which improves uplink performance. Furthermore, by establishing limits on how often and/or how much delay-sensitive data can be adjusted to a different LCH 610, some aspects described herein can prevent or mitigate scenarios where LCH adjustments may delay scheduling buffered uplink data in LCHs 610 with a high priority.

As indicated above, FIG. 6 is provided as an example. Other examples may differ from what is described with regard to FIG. 6.

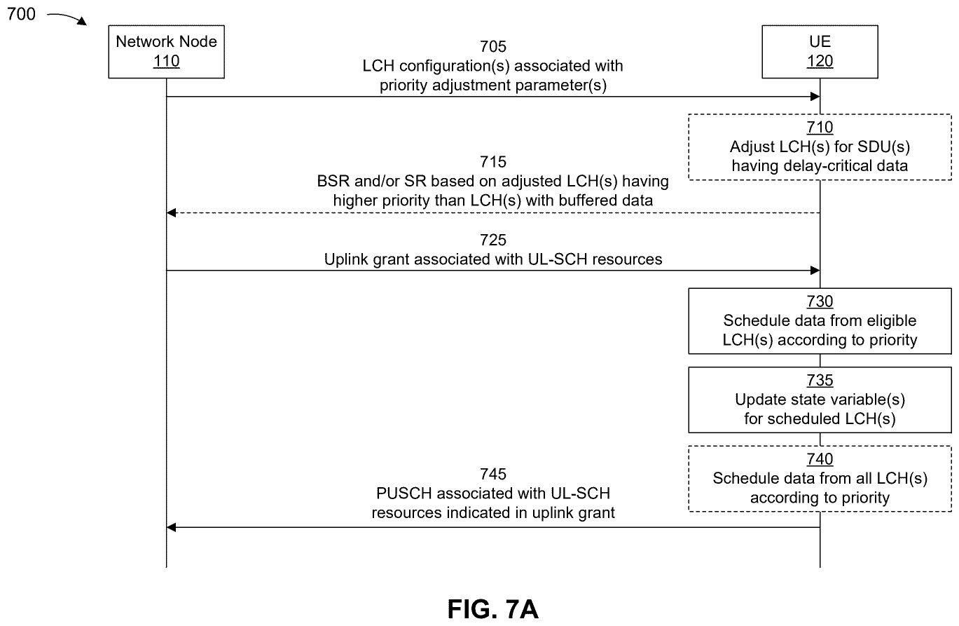

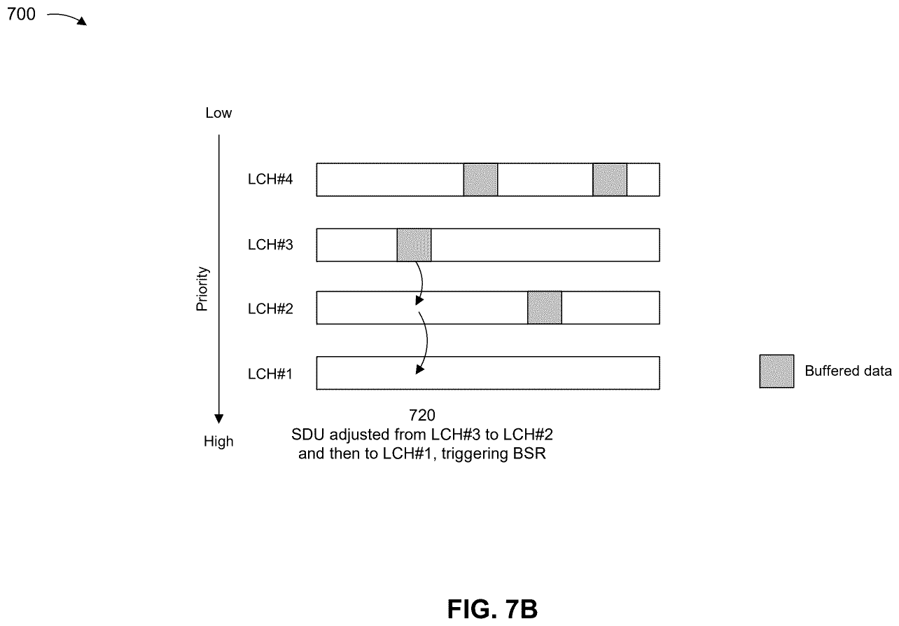

FIGS. 7A-7B is a diagram illustrating examples 700 associated with priority adjustment for LCHs. As shown in FIGS. 7A-7B, example 700 includes a network node 110 and a UE 120 that may communicate in a wireless network, such as wireless network 100. The network node 110 and the UE 120 may communicate via a wireless access link, which includes an uplink and a downlink.

As shown in FIG. 7A, and by reference number 705, the network node 110 may send or otherwise provide, and the UE 120 may receive, one or more LCH configurations that are each associated with one or more priority adjustment parameters. For example, as described herein, an LCH configuration may be provided in RRC signaling (e.g., in a LogicalChannelConfig information element), and may indicate parameters such as a priority (e.g., a value from 1 to 16, where 1 is a highest priority and 16 is a lowest priority), a PBR (e.g., 0, 8, 16, 32, . . . , 32768, or 65536 KBps, or infinity), and a BSD (e.g., 5, 10, 20, 50, 100, 150, 300, 500, or 1000 milliseconds). In addition, the LCH configuration may indicate one or more parameters that relate to scheduling restrictions for each LCH, such as subcarrier spacings allowed for uplink transmission, a maximum PUSCH duration allowed for uplink transmission, whether a CG can be used for uplink transmission, and/or serving cells allowed for uplink transmission, among other examples. In some aspects, the LCH configuration may indicate other suitable parameters, such as an identifier associated with an LCH group that includes the LCH and/or an identifier associated with an SR configuration applicable to the LCH, among other examples.

Furthermore, in addition to the various parameters described above, which may be used in an LCH prioritization procedure to determine an LCH is eligible to be scheduled using a resource allocation indicated in an uplink grant, the LCH configuration may be associated with one or more priority adjustment parameters that control whether and/or how an LCH may adjust buffered uplink data associated with the LCH to a different (target) LCH that may have a different (e.g., higher) priority. For example, in some aspects, the LCH configuration that the network node 110 provides for an LCH may indicate whether the LCH is allowed to dynamically adjust buffered uplink data to a different LCH, which may be referred to herein as a target LCH, a new LCH, an adjusted LCH, or the like. When data is dynamically adjusted to a new LCH, the data may be adjusted (e.g., reassigned) from a current LCH that may be the same as or different from an original LCH associated with the adjusted data, which may be referred to herein as a default LCH, an initial LCH, or the like. As described herein, adjustment to a different LCH may be equivalent to adjustment to a different priority, because an LCH and a priority generally have a one-to-one mapping.

Furthermore, in cases when an LCH is allowed to dynamically adjust buffered uplink data to a different LCH, the LCH configuration may indicate a threshold, S, on a remaining time associated with uplink data buffered in the LCH. For example, in some aspects, the remaining time associated with buffered uplink data may correspond to a residual value for a PDCP discard timer associated with the buffered uplink data. Accordingly, any buffered uplink data associated with a remaining time that satisfies (e.g., is below) the threshold S may be considered delay-critical data potentially eligible for LCH adjustment. In some aspects, the LCH configuration for an LCH that is allowed to dynamically adjust buffered uplink data to a different LCH may further indicate a target LCH to which any delay-critical data associated with the LCH can be adjusted, or a priority to which delay-critical data associated with the LCH can be adjusted since a one-to-one mapping is defined between LCHs and priorities. Furthermore, the LCH configuration may indicate how many times data from the LCH can be adjusted (e.g., only once, or another suitable number of times) or that data from the LCH can be adjusted an unlimited number of times without restriction, and/or a limit on the amount of data that can be adjusted to a different LCH (e.g., X bytes or kilobytes over Y slots or other transmission time intervals (TTIs), or over Z milliseconds or another duration).

As further shown in FIG. 7A, and by reference number 710, the UE 120 may adjust an LCH for one or more SDUs that have delay-critical data. For example, in some aspects, the UE 120 may perform the LCH adjustment in accordance with (e.g., prior to or during) an LCH prioritization procedure or at another suitable time. In some aspects, the UE 120 may perform the LCH adjustment for one or more SDUs that are associated with a current LCH that has not reached an adjustment limit, if configured, and have a remaining time that is below or otherwise satisfies the threshold S configured for the current LCH. In such cases, when an SDU in a current LCH has a remaining time that satisfies the threshold S configured for the current LCH and any adjustment limit associated with the current LCH has not been reached (or no adjustment limit is configured for the current LCH), the UE 120 may adjust (e.g., reassign) the SDU to an adjusted SDU or target SDU indicated in the LCH configuration associated with the current LCH. In cases where an adjustment limit is not configured for the current LCH (e.g., there is no limit on the number of times an SDU associated with the current LCH is allowed to be adjusted to a different LCH), the current LCH may be different from the original or initial LCH associated with the SDU. Furthermore, in some aspects, similar rules may be applied to determine whether the SDU is eligible to be adjusted in cases where the LCH configuration for the current LCH specifies a limit on the amount of data that can be adjusted to the target LCH (e.g., the SDU may not be adjusted to the target LCH if a limit on the amount of data that can be adjusted to the target LCH has been reached, or only a portion of the data associated with the SDU may be adjusted to the target LCH if the SDU has a size that exceeds the limit on the amount of data that can be adjusted to the target LCH). In cases where an adjustment limit is configured for the current LCH, the adjustment of the SDU to the target LCH may be counted toward the adjustment limit associated with the current LCH, which may be the same or different from an original LCH associated with the SDU.

In some aspects, after an SDU associated with delay-critical data has been adjusted to a target LCH, the UE 120 may apply one or more LCH prioritization restrictions configured for the target LCH. For example, in some aspects, the LCH prioritization restrictions may relate to whether an LCH is eligible or otherwise considered to be scheduled when an uplink grant is received. For example, the LCH prioritization restrictions may relate to the value of the state variable, Bj, for the target LCH, and/or other suitable parameters such as an allowed PHY priority index (e.g., where an SDU from an LCH can only be mapped to dynamic uplink grants indicating a PHY priority index equal to the allowed PHY priority index), allowed subcarrier spacings, and/or a maximum PUSCH duration, among other examples. In addition, the UE 120 may perform another LCH adjustment to adjust the SDU to a new LCH in cases where all other conditions described herein are satisfied (e.g., the SDU has a remaining time that satisfies the threshold configured for the current LCH and any adjustment limits associated with current LCH have not been reached).

As further shown in FIG. 7A, and by reference number 715, a BSR and/or an SR may be triggered at the UE 120 after the LCH associated with the SDU has been adjusted one or more times. For example, in some aspects, the UE 120 may transmit, and the network node 110 may receive or otherwise obtain, a BSR in accordance with an adjusted LCH associated with the SDU having a higher priority than the priority associated with any other LCH that has buffered data. For example, if an SDU is associated with an LCH having a numerical priority of 4 after the SDU is adjusted one or more times and an LCH with a (lower) numerical priority of 6 has buffered data, the UE 120 may transmit the BSR to the network node 110. For example, a BSR may be triggered when new uplink data arrives in an empty buffer, or when the new uplink data has a higher priority than any other uplink data in the buffer. FIG. 7B illustrates a specific example where the UE 120 may be configured with four LCHs, numbered LCH #1 through LCH #4, where LCH #1 has a highest priority and LCH #4 has a lowest priority. As shown in FIG. 7B, buffered data is present in LCH #2, LCH #3, and LCH #4. Accordingly, as shown by reference number 720, if the SDU in LCH #3 is adjusted to LCH #2 and then to LCH #1 (e.g., subject to the LCH adjustment criteria described herein), a BSR may be triggered because there was previously no uplink data in LCH #1 and LCH #1 has a higher priority than LCH #2 and LCH #4 that have buffered data (e.g., to inform the network node 110 that uplink data more urgent than previously reported uplink data is present in LCH #1). Furthermore, in cases where adjusting the SDU to a different LCH triggers a BSR, and the triggered BSR triggers an SR, the UE 120 may transmit, and the network node 110 may receive or otherwise obtain, an SR associated with an SR configuration (e.g., a PUCCH resource, an SR periodicity and offset, a maximum number of SR transmissions, and/or a prohibit timer value, among other examples) for the target LCH after all adjustments are complete. For example, in the scenario shown in FIG. 7B, an SR triggered by adjusting an SDU from LCH #3 to LCH #1 may be associated with an SR configuration for LCH #1.

Accordingly, as shown in FIG. 7A, and by reference number 725, the network node 110 may send or otherwise provide, and the UE 120 may receive, an uplink grant that indicates an uplink resource allocation for a PUSCH that may be mapped to UL-SCH resources. For example, in some aspects, the uplink grant may be carried in DCI and may indicate a frequency domain resource assignment, a time domain resource assignment, an MCS, a new data indicator (NDI), a redundancy version (RV), a HARQ process number, an UL-SCH indicator, and/or other suitable parameters. In some aspects, as shown by reference number 730, the UE 120 may then schedule data from one or more eligible LCHs according to a descending priority. For example, the one or more eligible LCHs may each have a state variable with a Bj value greater than 0, and may otherwise satisfy any LCH prioritization restrictions associated with the uplink grant. Furthermore, as described herein, when determining the one or more eligible LCHs after LCH adjustment has been performed for one or more SDUs, the one or more SDUs may be subject to any LCH prioritization restrictions associated with the LCH(s) to which the SDU(s) are assigned after the adjustment.

As further shown by reference number 735, the UE 120 may then update the state variable, Bj, for each eligible LCH that has been scheduled (e.g., by subtracting the size of the scheduled data from Bj). In some aspects, when an SDU that has been adjusted to a different LCH is multiplexed or otherwise included in a TB, the Bj value may be updated for the original or initial LCH associated with the SDU according to the size of the SDU (e.g., the Bj value is not updated for the adjusted LCH from which the SDU is scheduled, and the Bj value is not updated for any LCH from which the SDU is adjusted that is not the original LCH associated with the SDU). As further shown by reference number 740, any spare radio resources associated with the uplink grant may be used to schedule data from all LCHs that have buffered uplink data, without regard to the Bj value, according to strict priority (e.g., descending from highest to lowest priority). As shown by reference number 745, the UE 120 may then transmit, and the network node 110 may receive or otherwise obtain, a PUSCH associated with UL-SCH resources indicated in the uplink grant.

As indicated above, FIGS. 7A-7B are provided as examples. Other examples may differ from what is described with regard to FIGS. 7A-7B.

FIG. 8 is a diagram illustrating an example process 800 performed, for example, at a UE or an apparatus of a UE. Example process 800 is an example where the apparatus or the UE (e.g., UE 120) performs operations associated with priority adjustment for LCHs.

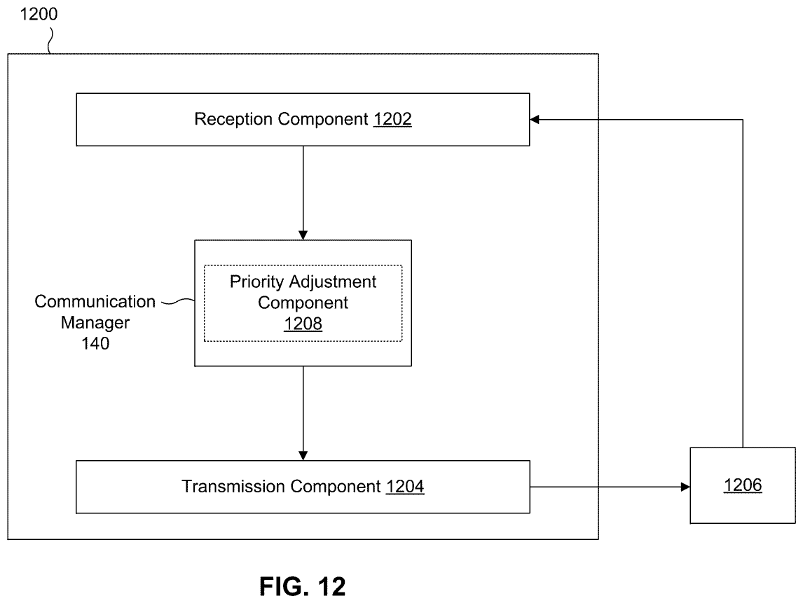

As shown in FIG. 8, in some aspects, process 800 may include receiving a configuration associated with an LCH with a first priority, wherein the configuration indicates one or more parameters to adjust data assigned to the LCH from the first priority to a second priority (block 810). For example, the UE (e.g., using communication manager 140 and/or reception component 1202, depicted in FIG. 12) may receive a configuration associated with an LCH with a first priority, wherein the configuration indicates one or more parameters to adjust data assigned to the LCH from the first priority to a second priority, as described above.

As further shown in FIG. 8, in some aspects, process 800 may include adjusting a priority of an SDU associated with the LCH to the second priority in accordance with the one or more parameters (block 820). For example, the UE (e.g., using communication manager 140 and/or LCH adjustment component 1208, depicted in FIG. 12) may a priority of an SDU associated with the LCH to the second priority in accordance with the one or more parameters, as described above.

As further shown in FIG. 8, in some aspects, process 800 may include transmitting the SDU via UL-SCH resources based at least in part on the second priority (block 830). For example, the UE (e.g., using communication manager 140 and/or transmission component 1204, depicted in FIG. 12) may transmit the SDU via UL-SCH resources based at least in part on the second priority, as described above.

Process 800 may include additional aspects, such as any single aspect or any combination of aspects described below and/or in connection with one or more other processes described elsewhere herein.

In a first aspect, the configuration indicates whether the data assigned to the LCH is allowed to be adjusted to the second priority.

In a second aspect, alone or in combination with the first aspect, the configuration indicates a threshold associated with a remaining time of data in the LCH.

In a third aspect, alone or in combination with one or more of the first and second aspects, adjusting the priority of the SDU comprises adjusting the priority of the SDU to the second priority in accordance with a determination that the SDU has a remaining time that satisfies the threshold.

In a fourth aspect, alone or in combination with one or more of the first through third aspects, the remaining time associated with the SDU is a residual value of a PDCP discard timer associated with the SDU.

In a fifth aspect, alone or in combination with one or more of the first through fourth aspects, the configuration indicates the second priority.

In a sixth aspect, alone or in combination with one or more of the first through fifth aspects, the configuration indicates a maximum number of times that the data associated with the LCH can be adjusted.

In a seventh aspect, alone or in combination with one or more of the first through sixth aspects, adjusting the priority of the SDU comprises adjusting the priority of the SDU to the second priority in accordance with a determination that data associated with the LCH has been adjusted to the second priority a number of times that is less than the maximum number of times.

In an eighth aspect, alone or in combination with one or more of the first through seventh aspects, the configuration indicates a limit on an amount of data associated with the LCH that can be adjusted to the second priority.

In a ninth aspect, alone or in combination with one or more of the first through eighth aspects, the limit on the amount of data that can be adjusted to the second priority relates to a maximum data size over a duration.

In a tenth aspect, alone or in combination with one or more of the first through ninth aspects, process 800 includes scheduling the SDU for transmission via the UL-SCH resources in accordance with an LCH prioritization restriction associated with the second priority.

In an eleventh aspect, alone or in combination with one or more of the first through tenth aspects, process 800 includes adjusting a scheduling eligibility state variable associated with an original priority associated with the SDU based at least in part on transmission of the SDU.

In a twelfth aspect, alone or in combination with one or more of the first through eleventh aspects, process 800 includes transmitting a BSR based at least in part on a determination that the second priority is higher than one or more priorities associated with one or more LCHs that have buffered data.

In a thirteenth aspect, alone or in combination with one or more of the first through twelfth aspects, process 800 includes transmitting an SR triggered by the BSR in accordance with an SR configuration associated with the second priority.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with priority adjustment for LCHs.

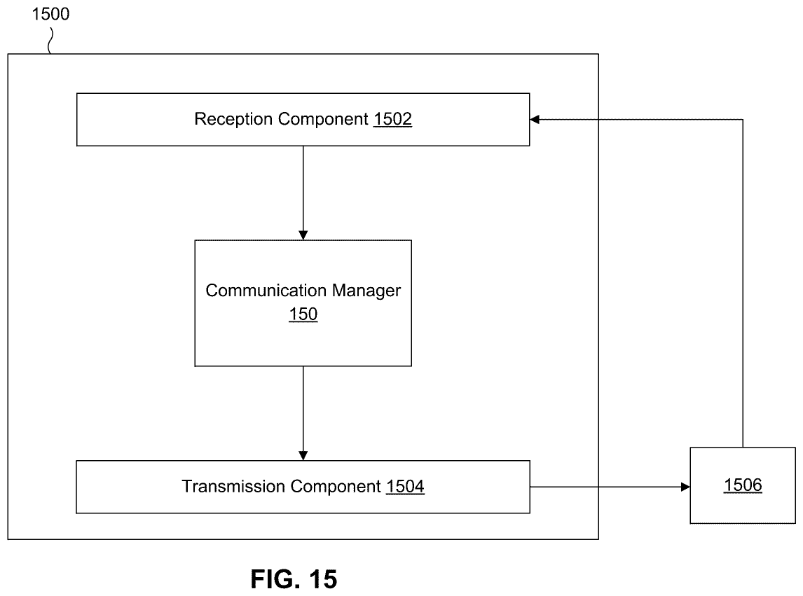

As shown in FIG. 9, in some aspects, process 900 may include sending a configuration associated with priority adjustment associated with an LCH with a first priority, wherein the configuration indicates one or more parameters to adjust data assigned to the LCH from the first priority to a second priority (block 910). For example, the network node (e.g., using communication manager 150 and/or transmission component 1504, depicted in FIG. 15) may send a configuration associated with priority adjustment associated with an LCH with a first priority, wherein the configuration indicates one or more parameters to adjust data assigned to the LCH from the first priority to a second priority, as described above.

As further shown in FIG. 9, in some aspects, process 900 may include obtaining an SDU via UL-SCH resources in accordance with the second priority (block 920). For example, the network node (e.g., using communication manager 150 and/or reception component 1502, depicted in FIG. 15) may obtain an SDU via UL-SCH resources in accordance with the second priority, as described above.

Process 900 may include additional aspects, such as any single aspect or any combination of aspects described below and/or in connection with one or more other processes described elsewhere herein.

In a first aspect, the configuration indicates whether the data assigned to the LCH is allowed to be adjusted to the second priority.

In a second aspect, alone or in combination with the first aspect, the configuration indicates a threshold associated with a remaining time of data in the LCH.

In a third aspect, alone or in combination with one or more of the first and second aspects, the configuration indicates the second priority.

In a fourth aspect, alone or in combination with one or more of the first through third aspects, the configuration indicates a maximum number of times that the data associated with the LCH can be adjusted.

In a fifth aspect, alone or in combination with one or more of the first through fourth aspects, the configuration indicates a limit on an amount of data associated with the LCH that can be adjusted to the second priority.

In a sixth aspect, alone or in combination with one or more of the first through fifth aspects, the limit on the amount of data that can be adjusted to the second priority relates to a maximum data size over a duration.

In a seventh aspect, alone or in combination with one or more of the first through sixth aspects, process 900 includes obtaining a BSR based at least in part on the second priority that is higher than one or more priorities associated with one or more LCHs that have buffered data.

In an eighth aspect, alone or in combination with one or more of the first through seventh aspects, process 900 includes obtaining an SR triggered by the BSR in accordance with an SR configuration associated with the second priority.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 120) performs operations associated with priority adjustment for logical channels.

As shown in FIG. 10, in some aspects, process 1000 may include receiving a configuration associated with a first LCH with a first priority, wherein the configuration indicates one or more priority adjustment parameters for data assigned to the first LCH (block 1010). For example, the UE (e.g., using communication manager 140 or reception component 1202, depicted in FIG. 12) may receive a configuration associated with a first LCH with a first priority, wherein the configuration indicates one or more priority adjustment parameters for data assigned to the first LCH, as described above.

As further shown in FIG. 10, in some aspects, process 1000 may include adjusting an SDU associated with the first LCH to a second LCH with a second priority in accordance with the one or more priority adjustment parameters (block 1020). For example, the UE (e.g., using communication manager 140 or priority adjustment component 1208, depicted in FIG. 12) may adjust an SDU associated with the first LCH to a second LCH with a second priority in accordance with the one or more priority adjustment parameters, as described above.

As further shown in FIG. 10, in some aspects, process 1000 may include transmitting the SDU via UL-SCH resources based at least in part on the second priority associated with the second LCH (block 1030). For example, the UE (e.g., using communication manager 140 or transmission component 1204, depicted in FIG. 12) may transmit the SDU via UL-SCH resources based at least in part on the second priority associated with the second LCH, as described above.

Process 1000 may include additional aspects, such as any single aspect or any combination of aspects described below or in connection with one or more other processes described elsewhere herein.

In a first aspect, the configuration indicates whether the data assigned to the first LCH is allowed to be adjusted to the second LCH.

In a second aspect, alone or in combination with the first aspect, the configuration indicates a threshold associated with a remaining time of data in the first LCH.

In a third aspect, alone or in combination with one or more of the first and second aspects, adjusting the SDU includes adjusting the SDU to the second LCH in accordance with a determination that the SDU has a remaining time that satisfies the threshold.

In a fourth aspect, alone or in combination with one or more of the first through third aspects, the remaining time associated with the SDU is a residual value of a PDCP discard timer associated with the SDU.

In a fifth aspect, alone or in combination with one or more of the first through fourth aspects, the configuration indicates the second LCH.

In a sixth aspect, alone or in combination with one or more of the first through fifth aspects, the configuration indicates a maximum number of times that the data associated with the first LCH can be adjusted.

In a seventh aspect, alone or in combination with one or more of the first through sixth aspects, adjusting the SDU includes adjusting the SDU to the second LCH in accordance with a determination that data associated with the first LCH has been adjusted to the second LCH a number of times that is less than the maximum number of times.

In an eighth aspect, alone or in combination with one or more of the first through seventh aspects, the configuration indicates a limit on an amount of data associated with the first LCH that can be adjusted to the second LCH.

In a ninth aspect, alone or in combination with one or more of the first through eighth aspects, the limit on the amount of data that can be adjusted to the second LCH relates to a maximum data size over a duration.

In a tenth aspect, alone or in combination with one or more of the first through ninth aspects, process 1000 includes scheduling the SDU for transmission via the UL-SCH resources in accordance with an LCH prioritization restriction associated with the second LCH.

In an eleventh aspect, alone or in combination with one or more of the first through tenth aspects, process 1000 includes adjusting a scheduling eligibility state variable associated with an original LCH associated with the SDU based at least in part on transmission of the SDU.

In a twelfth aspect, alone or in combination with one or more of the first through eleventh aspects, process 1000 includes transmitting a BSR based at least in part on a determination that the second priority associated with the second LCH is higher than one or more priorities associated with one or more LCHs that have buffered data.

In a thirteenth aspect, alone or in combination with one or more of the first through twelfth aspects, process 1000 includes transmitting an SR triggered by the BSR in accordance with an SR configuration associated with the second LCH.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with priority adjustment for logical channels.

As shown in FIG. 11, in some aspects, process 1100 may include sending a configuration associated with priority adjustment associated with a first LCH with a first priority, wherein the configuration indicates one or more priority adjustment parameters for data assigned to the first LCH (block 1110). For example, the network node (e.g., using communication manager 150 or transmission component 1504, depicted in FIG. 15) may send a configuration associated with priority adjustment associated with a first LCH with a first priority, wherein the configuration indicates one or more priority adjustment parameters for data assigned to the first LCH, as described above.

As further shown in FIG. 11, in some aspects, process 1100 may include obtaining an SDU via UL-SCH resources in accordance with a second priority associated with a second LCH (block 1120). For example, the network node (e.g., using communication manager 150 or reception component 1502, depicted in FIG. 15) may obtain an SDU via UL-SCH resources in accordance with a second priority associated with a second LCH, as described above.

Process 1100 may include additional aspects, such as any single aspect or any combination of aspects described below or in connection with one or more other processes described elsewhere herein.

In a first aspect, the configuration indicates whether the data assigned to the first LCH is allowed to be adjusted to the second LCH.

In a second aspect, alone or in combination with the first aspect, the configuration indicates a threshold associated with a remaining time of data in the first LCH.

In a third aspect, alone or in combination with one or more of the first and second aspects, the configuration indicates the second LCH.

In a fourth aspect, alone or in combination with one or more of the first through third aspects, the configuration indicates a maximum number of times that the data associated with the first LCH can be adjusted.

In a fifth aspect, alone or in combination with one or more of the first through fourth aspects, the configuration indicates a limit on an amount of data associated with the first LCH that can be adjusted to the second LCH.

In a sixth aspect, alone or in combination with one or more of the first through fifth aspects, the limit on the amount of data that can be adjusted to the second LCH relates to a maximum data size over a duration.

In a seventh aspect, alone or in combination with one or more of the first through sixth aspects, process 1100 includes obtaining a BSR based at least in part on the second priority associated with the second LCH that is higher than one or more priorities associated with one or more LCHs that have buffered data.

In an eighth aspect, alone or in combination with one or more of the first through seventh aspects, process 1100 includes obtaining an SR triggered by the BSR in accordance with an SR configuration associated with the second LCH.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include an LCH adjustment component 1208, among other examples.

In some aspects, the apparatus 1200 may be configured to perform one or more operations described herein in connection with FIG. 6 and/or FIGS. 7A-7B. Additionally, or alternatively, the apparatus 1200 may be configured to perform one or more processes described herein, such as process 800 of FIG. 8, process 1000 of FIG. 8, or a combination thereof. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The reception component 1202 may receive a configuration associated with an LCH with a first priority, wherein the configuration indicates one or more parameters to adjust data assigned to the LCH from the first priority to a second priority. The LCH adjustment component 1208 may adjust a priority of an SDU associated with the LCH to the second priority in accordance with the one or more parameters. The transmission component 1204 may transmit the SDU via UL-SCH resources based at least in part on the second priority.

The LCH adjustment component 1208 may schedule the SDU for transmission via the UL-SCH resources in accordance with an LCH prioritization restriction associated with the second priority.

The LCH adjustment component 1208 may adjust a scheduling eligibility state variable associated with an original priority associated with the SDU based at least in part on transmission of the SDU.

The transmission component 1204 may transmit a BSR based at least in part on a determination that the second priority is higher than one or more priorities associated with one or more LCHs that have buffered data.

The transmission component 1204 may transmit an SR triggered by the BSR in accordance with an SR configuration associated with the second priority.

The reception component 1202 may receive a configuration associated with a first LCH with a first priority, wherein the configuration indicates one or more priority adjustment parameters for data assigned to the first LCH. The priority adjustment component 1208 may adjust an SDU associated with the first LCH to a second LCH with a second priority in accordance with the one or more priority adjustment parameters. The transmission component 1204 may transmit the SDU via UL-SCH resources based at least in part on the second priority associated with the second LCH.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

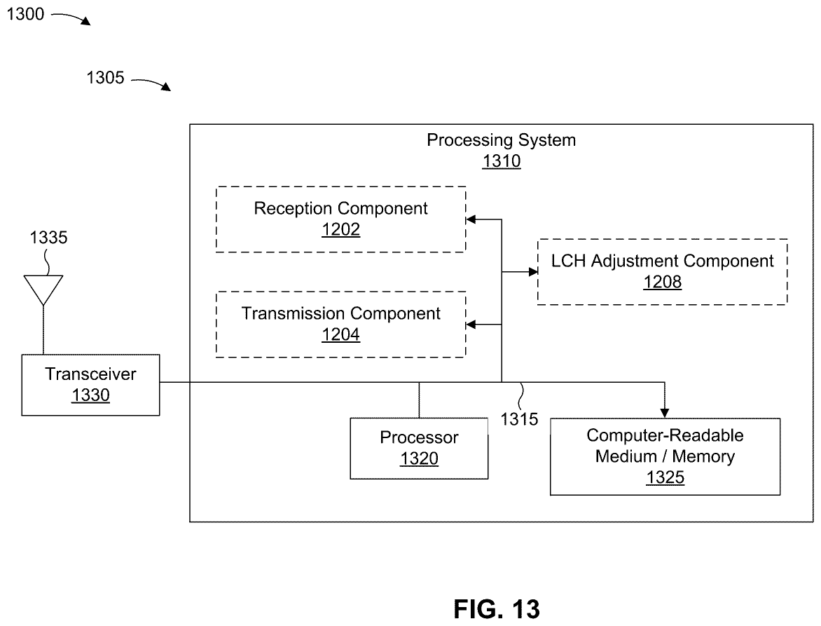

FIG. 13 is a diagram illustrating an example 1300 of a hardware implementation for an apparatus 1305 employing a processing system 1310. The apparatus 1305 may be a UE or may be at (e.g., included in) a UE.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include one or more memories, such as the memory 282, and/or may include one or more processors, such as at least one of the TX MIMO processor 266, the RX processor 258, and/or the controller/processor 280. In some aspects, the apparatus 1305 for wireless communication includes means for receiving a configuration associated with an LCH with a first priority, wherein the configuration indicates one or more parameters to adjust data assigned to the LCH from the first priority to a second priority, means for adjusting a priority of an SDU associated with the LCH to the second priority in accordance with the one or more parameters, and/or means for transmitting the SDU via UL-SCH resources based at least in part on the second priority. In some aspects, the apparatus 1305 for wireless communication includes means for receiving a configuration associated with a first LCH with a first priority, wherein the configuration indicates one or more priority adjustment parameters for data assigned to the first LCH, means for adjusting an SDU associated with the first LCH to a second LCH with a second priority in accordance with the one or more priority adjustment parameters, and/or means for transmitting the SDU via UL-SCH resources based at least in part on the second priority associated with the second LCH. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 13 is provided as an example. Other examples may differ from what is described in connection with FIG. 13.

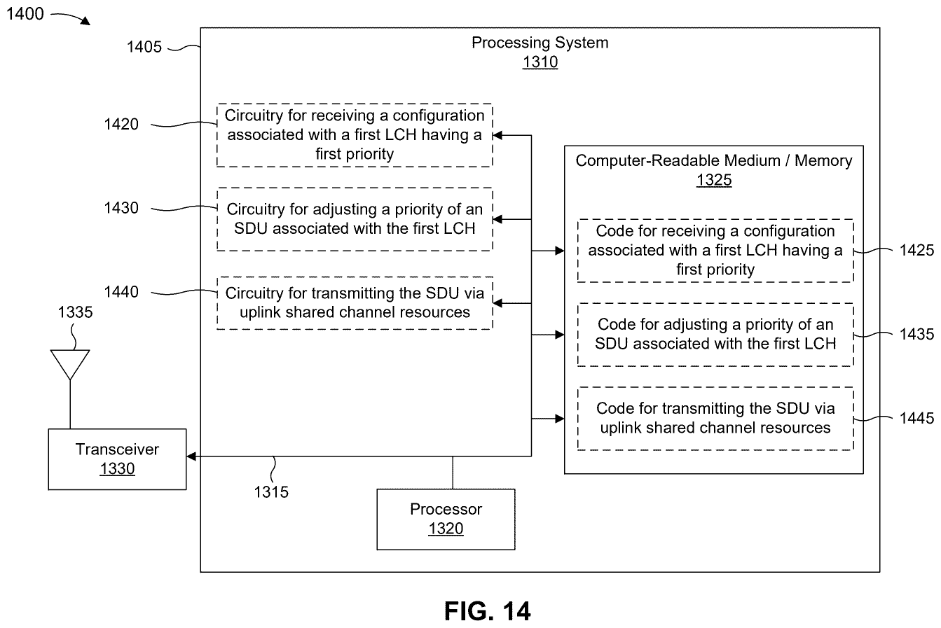

FIG. 14 is a diagram illustrating an example 1400 of an implementation of code and circuitry for an apparatus 1405. The apparatus 1405 may be a UE, or a UE may include the apparatus 1405.

As shown in FIG. 14, the apparatus 1405 may include circuitry for receiving a configuration associated with a first LCH having a first priority (circuitry 1420). For example, the circuitry 1420 may enable the apparatus 1405 to receive a configuration associated with a first LCH having a first priority. Additionally, or alternatively, the circuitry 1420 may enable the apparatus 1405 to receive a configuration associated with a first LCH with a first priority, wherein the configuration indicates one or more priority adjustment parameters for data assigned to the first LCH.

As shown in FIG. 14, the apparatus 1405 may include, stored in computer-readable medium 1325, code for receiving a configuration associated with a first LCH having a first priority (code 1425). For example, the code 1425, when executed by processor 1320, may cause processor 1320 to cause transceiver 1330 to receive a configuration associated with a first LCH having a first priority. Additionally, or alternatively, the code 1425, when executed by processor 1320, may cause processor 1320 to cause transceiver 1330 to receive a configuration associated with a first LCH with a first priority, wherein the configuration indicates one or more priority adjustment parameters for data assigned to the first LCH.

As shown in FIG. 14, the apparatus 1405 may include circuitry for adjusting a priority of an SDU associated with the first LCH (circuitry 1430). For example, the circuitry 1430 may enable the apparatus 1405 to adjust an SDU associated with the first LCH to a second LCH having a second priority according to the configuration associated with the first LCH. For example, the circuitry 1430 may enable the apparatus 1405 to adjust an SDU associated with the first LCH to a second LCH with a second priority in accordance with the one or more priority adjustment parameters.

As shown in FIG. 14, the apparatus 1405 may include, stored in computer-readable medium 1325, code for adjusting a priority of an SDU associated with the first LCH (code 1435). For example, the code 1435, when executed by processor 1320, may cause processor 1320 to adjust an SDU associated with the first LCH to a second LCH having a second priority according to the configuration associated with the first LCH. For example, the code 1435, when executed by processor 1320, may cause processor 1320 to adjust an SDU associated with the first LCH to a second LCH with a second priority in accordance with the one or more priority adjustment parameters.

As shown in FIG. 14, the apparatus 1405 may include circuitry for transmitting the SDU via UL-SCH resources based at least in part on the second priority associated with the second LCH (circuitry 1440). For example, the circuitry 1440 may enable the apparatus 1405 to transmit the SDU via UL-SCH resources based at least in part on the second priority associated with the second LCH. For example, the circuitry 1440 may enable the apparatus 1405 to transmit the SDU via UL-SCH resources based at least in part on the second priority associated with the second LCH.

As shown in FIG. 14, the apparatus 1405 may include, stored in computer-readable medium 1325, code for transmitting the SDU via UL-SCH resources based at least in part on the second priority associated with the second LCH (code 1445). For example, the code 1445, when executed by processor 1320, may cause processor 1320 to cause transceiver 1330 to transmit the SDU via UL-SCH resources based at least in part on the second priority associated with the second LCH. For example, the code 1445, when executed by processor 1320, may cause processor 1320 to cause transceiver 1330 to transmit the SDU via UL-SCH resources based at least in part on the second priority associated with the second LCH.

FIG. 14 is provided as an example. Other examples may differ from what is described in connection with FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150.

In some aspects, the apparatus 1500 may be configured to perform one or more operations described herein in connection with FIG. 6 and/or FIGS. 7A-7B. Additionally, or alternatively, the apparatus 1500 may be configured to perform one or more processes described herein, such as process 900 of FIG. 9, process 1100 of FIG. 9, or a combination thereof. In some aspects, the apparatus 1500 and/or one or more components shown in FIG. 15 may include one or more components of the network node described in connection with FIG. 1 and FIG. 2. Additionally, or alternatively, one or more components shown in FIG. 15 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1504 may be co-located with the reception component 1502 in one or more transceivers.

The transmission component 1504 may send a configuration associated with priority adjustment associated with an LCH with a first priority, wherein the configuration indicates one or more parameters to adjust data assigned to the LCH from the first priority to a second priority. The reception component 1502 may an SDU via UL-SCH resources in accordance with the second priority.

The reception component 1502 may obtain a BSR based at least in part on a determination that the second priority is higher than one or more priorities associated with one or more LCHs that have buffered data.

The reception component 1502 may obtain an SR triggered by the BSR in accordance with an SR configuration associated with the second priority.

The transmission component 1504 may send a configuration associated with priority adjustment associated with a first LCH with a first priority, wherein the configuration indicates one or more priority adjustment parameters for data assigned to the first LCH. The reception component 1502 may obtain an SDU via UL-SCH resources in accordance with a second priority associated with a second LCH.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

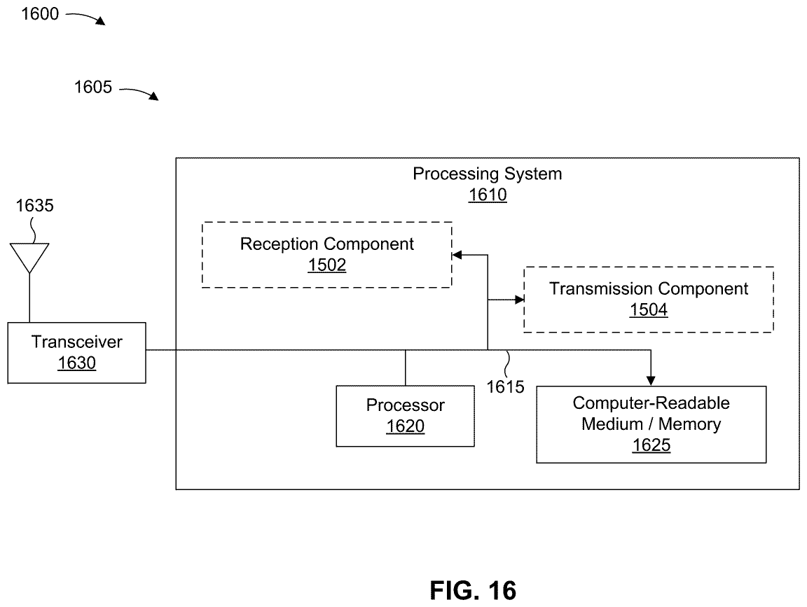

FIG. 16 is a diagram illustrating an example 1600 of a hardware implementation for an apparatus 1605 employing a processing system 1610. The apparatus 1605 may be a UE or may be at (e.g., included in) a UE.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software. The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1605 for wireless communication includes means for sending a configuration associated with priority adjustment associated with an LCH with a first priority, wherein the configuration indicates one or more parameters to adjust data assigned to the LCH from the first priority to a second priority and/or means for obtaining an SDU via UL-SCH resources in accordance with the second priority. In some aspects, the apparatus 1605 for wireless communication includes means for sending a configuration associated with priority adjustment associated with a first LCH with a first priority, wherein the configuration indicates one or more priority adjustment parameters for data assigned to the first LCH and/or means for obtaining an SDU via UL-SCH resources in accordance with a second priority associated with a second LCH. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 16 is provided as an example. Other examples may differ from what is described in connection with FIG. 16.

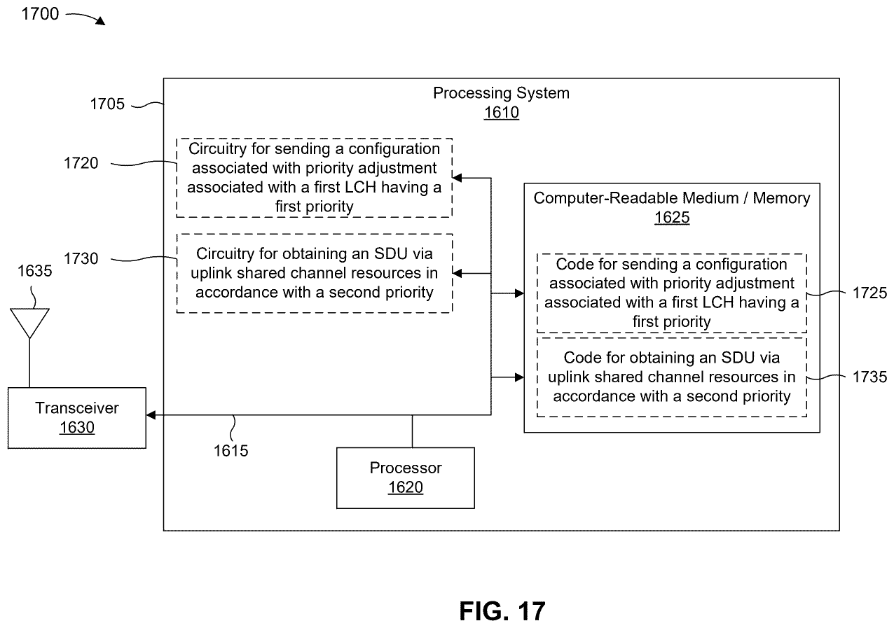

FIG. 17 is a diagram illustrating an example 1700 of an implementation of code and circuitry for an apparatus 1705. The apparatus 1705 may be a network node, or a network node may include the apparatus 1705.

As shown in FIG. 17, the apparatus 1705 may include circuitry for sending a configuration associated with priority adjustment associated with a first LCH having a first priority (circuitry 1720). For example, the circuitry 1720 may enable the apparatus 1705 to send a configuration associated with priority adjustment associated with a first LCH having a first priority. For example, the circuitry 1720 may enable the apparatus 1705 to a configuration associated with priority adjustment associated with a first LCH with a first priority, wherein the configuration indicates one or more priority adjustment parameters for data assigned to the first LCH.

As shown in FIG. 17, the apparatus 1705 may include, stored in computer-readable medium 1625, code for sending a configuration associated with priority adjustment associated with a first LCH having a first priority (code 1725). For example, the code 1725, when executed by processor 1620, may cause processor 1620 to cause transceiver 1630 to send a configuration associated with priority adjustment associated with a first LCH having a first priority. For example, the code 1725, when executed by processor 1620, may cause processor 1620 to cause transceiver 1630 to send a configuration associated with priority adjustment associated with a first LCH with a first priority, wherein the configuration indicates one or more priority adjustment parameters for data assigned to the first LCH.

As shown in FIG. 17, the apparatus 1705 may include circuitry for obtaining an SDU via UL-SCH resources in accordance with a second priority (circuitry 1730). For example, the circuitry 1730 may enable the apparatus 1705 to obtain an SDU via UL-SCH resources in accordance with a second priority associated with a second LCH. For example, the circuitry 1730 may enable the apparatus 1705 to an SDU via UL-SCH resources in accordance with a second priority associated with a second LCH.

As shown in FIG. 17, the apparatus 1705 may include, stored in computer-readable medium 1625, code for obtaining an SDU via UL-SCH resources in accordance with a second priority (code 1735). For example, the code 1735, when executed by processor 1620, may cause processor 1620 to cause transceiver 1630 to obtain an SDU via UL-SCH resources in accordance with a second priority associated with a second LCH. For example, the code 1735, when executed by processor 1620, may cause processor 1620 to cause transceiver 1630 to an SDU via UL-SCH resources in accordance with a second priority associated with a second LCH.

FIG. 17 is provided as an example. Other examples may differ from what is described in connection with FIG. 17.

The following provides an overview of some Aspects of the present disclosure:

Aspect 1: A method of wireless communication performed at a UE, comprising: receiving a configuration associated with an LCH with a first priority, wherein the configuration indicates one or more parameters to adjust data assigned to the LCH from the first priority to a second priority; adjusting a priority of an SDU associated with the LCH to the second priority in accordance with the one or more parameters; and transmitting the SDU via UL-SCH resources based at least in part on the second priority.

Aspect 2: The method of Aspect 1, wherein the configuration indicates whether the data assigned to the LCH is allowed to be adjusted to the second priority.

Aspect 3: The method of any of Aspects 1-2, wherein the configuration indicates a threshold associated with a remaining time of data in the LCH.

Aspect 4: The method of Aspect 3, wherein adjusting the priority of the SDU comprises: adjusting the priority of the SDU to the second priority in accordance with the SDU having a remaining time that satisfies the threshold.

Aspect 5: The method of Aspect 4, wherein the remaining time associated with the SDU is a residual value of a PDCP discard timer associated with the SDU.

Aspect 6: The method of any of Aspects 1-5, wherein the configuration indicates the second priority.

Aspect 7: The method of any of Aspects 1-6, wherein the configuration indicates a maximum number of times that the data associated with the LCH can be adjusted.

Aspect 8: The method of Aspect 7, wherein adjusting the priority of the SDU comprises: adjusting the priority of the SDU to the second priority in accordance with data associated with the LCH having been adjusted to the second priority a number of times that is less than the maximum number of times.

Aspect 9: The method of any of Aspects 1-8, wherein the configuration indicates a limit on an amount of data associated with the LCH that can be adjusted to the second priority.

Aspect 10: The method of Aspect 9, wherein the limit on the amount of data that can be adjusted to the second priority relates to a maximum data size over a duration.

Aspect 11: The method of any of Aspects 1-10, further comprising: scheduling the SDU for transmission via the UL-SCH resources in accordance with an LCH prioritization restriction associated with the second priority.

Aspect 12: The method of any of Aspects 1-11, further comprising: adjusting a scheduling eligibility state variable associated with an original LCH associated with the SDU based at least in part on transmitting the SDU.

Aspect 13: The method of any of Aspects 1-12, further comprising:

transmitting a BSR based at least in part on the second priority being higher than one or more priorities associated with one or more LCHs that have buffered data.

Aspect 14: The method of Aspect 13, further comprising: transmitting an SR triggered by the BSR in accordance with an SR configuration associated with the second priority.

Aspect 15: A method of wireless communication performed at a network node, comprising: sending a configuration associated with priority adjustment associated with an LCH with a first priority, wherein the configuration indicates one or more parameters to adjust data assigned to the LCH from the first priority to a second priority; and obtaining an SDU via UL-SCH resources in accordance with the second priority.

Aspect 16: The method of Aspect 15, wherein the configuration indicates whether the data assigned to the LCH is allowed to be adjusted to the second priority.

Aspect 17: The method of any of Aspects 15-16, wherein the configuration indicates a threshold associated with a remaining time of data in the LCH.

Aspect 18: The method of any of Aspects 15-17, wherein the configuration indicates the second priority.

Aspect 19: The method of any of Aspects 15-18, wherein the configuration indicates a maximum number of times that the data associated with the LCH can be adjusted.

Aspect 20: The method of any of Aspects 15-19, wherein the configuration indicates a limit on an amount of data associated with the LCH that can be adjusted to the second priority.

Aspect 21: The method of Aspect 20, wherein the limit on the amount of data that can be adjusted to the second priority relates to a maximum data size over a duration.

Aspect 22: The method of any of Aspects 15-21, further comprising: obtaining a BSR based at least in part on the second priority being higher than one or more priorities associated with one or more LCHs that have buffered data.

Aspect 23: The method of Aspect 22, further comprising: obtaining an SR triggered by the BSR in accordance with an SR configuration associated with the second priority.

Aspect 24: A method of wireless communication performed at a UE, comprising: receiving a configuration associated with a first LCH with a first priority, wherein the configuration indicates one or more priority adjustment parameters for data assigned to the first LCH; adjusting an SDU associated with the first LCH to a second LCH with a second priority in accordance with the one or more priority adjustment parameters; and transmitting the SDU via UL-SCH resources based at least in part on the second priority associated with the second LCH.

Aspect 25: The method of Aspect 24, wherein the configuration indicates whether the data assigned to the first LCH is allowed to be adjusted to the second LCH.

Aspect 26: The method of any of Aspects 24-25, wherein the configuration indicates a threshold associated with a remaining time of data in the first LCH.

Aspect 27: The method of Aspect 26, wherein adjusting the SDU includes: adjusting the SDU to the second LCH in accordance with a determination that the SDU has a remaining time that satisfies the threshold.

Aspect 28: The method of Aspect 27, wherein the remaining time associated with the SDU is a residual value of a PDCP discard timer associated with the SDU.

Aspect 29: The method of any of Aspects 24-28, wherein the configuration indicates the second LCH.

Aspect 30: The method of any of Aspects 24-29, wherein the configuration indicates a maximum number of times that the data associated with the first LCH can be adjusted.

Aspect 31: The method of Aspect 30, wherein adjusting the SDU includes: adjusting the SDU to the second LCH in accordance with a determination that data associated with the first LCH has been adjusted to the second LCH a number of times that is less than the maximum number of times.

Aspect 32: The method of any of Aspects 24-31, wherein the configuration indicates a limit on an amount of data associated with the first LCH that can be adjusted to the second LCH.

Aspect 33: The method of Aspect 32, wherein the limit on the amount of data that can be adjusted to the second LCH relates to a maximum data size over a duration.

Aspect 34: The method of any of Aspects 24-33, further comprising: scheduling the SDU for transmission via the UL-SCH resources in accordance with an LCH prioritization restriction associated with the second LCH.

Aspect 35: The method of any of Aspects 24-34, further comprising: adjusting a scheduling eligibility state variable associated with an original LCH associated with the SDU based at least in part on transmission of the SDU.

Aspect 36: The method of any of Aspects 24-35, further comprising: transmitting a BSR based at least in part on a determination that the second priority associated with the second LCH is higher than one or more priorities associated with one or more LCHs that have buffered data.

Aspect 37: The method of Aspect 36, further comprising: transmitting an SR triggered by the BSR in accordance with an SR configuration associated with the second LCH.

Aspect 38: A method of wireless communication performed at a network node, comprising: sending a configuration associated with priority adjustment associated with a first LCH with a first priority, wherein the configuration indicates one or more priority adjustment parameters for data assigned to the first LCH; and obtaining an SDU via UL-SCH resources in accordance with a second priority associated with a second LCH.

Aspect 39: The method of Aspect 38, wherein the configuration indicates whether the data assigned to the first LCH is allowed to be adjusted to the second LCH.

Aspect 40: The method of any of Aspects 38-39, wherein the configuration indicates a threshold associated with a remaining time of data in the first LCH.

Aspect 41: The method of any of Aspects 38-40, wherein the configuration indicates the second LCH.

Aspect 42: The method of any of Aspects 38-41, wherein the configuration indicates a maximum number of times that the data associated with the first LCH can be adjusted.

Aspect 43: The method of any of Aspects 38-42, wherein the configuration indicates a limit on an amount of data associated with the first LCH that can be adjusted to the second LCH.

Aspect 44: The method of any of Aspects 38-43, wherein the limit on the amount of data that can be adjusted to the second LCH relates to a maximum data size over a duration.

Aspect 45: The method of any of Aspects 38-44, further comprising: obtaining a BSR based at least in part on the second priority associated with the second LCH that is higher than one or more priorities associated with one or more LCHs that have buffered data.

Aspect 46: The method of any of Aspects 38-45, further comprising: obtaining an SR triggered by the BSR in accordance with an SR configuration associated with the second LCH.

Aspect 46: A method of wireless communication performed at a UE, comprising: receiving a configuration associated with a first LCH having a first priority; adjusting an SDU associated with the first LCH to a second LCH having a second priority according to the configuration associated with the first LCH; and transmitting the SDU via UL-SCH resources based at least in part on the second priority associated with the second LCH.

Aspect 47: The method of Aspect 46, wherein the configuration indicates whether the data assigned to the first LCH is allowed to be adjusted to the second LCH.

Aspect 48: The method of any of Aspects 46-47, wherein the configuration indicates a threshold associated with a remaining time of data in the first LCH.

Aspect 49: The method of Aspect 48, wherein adjusting the SDU comprises: adjusting the SDU to the second LCH in accordance with the SDU having a remaining time that satisfies the threshold.

Aspect 50: The method of Aspect 49, wherein the remaining time associated with SDU is a residual value of a PDCP discard timer associated with the SDU.

Aspect 51: The method of any of Aspects 46-50, wherein the configuration indicates the second LCH.

Aspect 52: The method of any of Aspects 46-51, wherein the configuration indicates a maximum number of times that the data associated with the first LCH can be adjusted.

Aspect 53: The method of Aspect 52, wherein adjusting the SDU comprises: adjusting the SDU to the second LCH in accordance with data associated with the first LCH having been adjusted to the second LCH a number of times that is less than the maximum number of times.

Aspect 54: The method of any of Aspects 46-53, wherein the configuration indicates a limit on an amount of data associated with the first LCH that can be adjusted to the second LCH.

Aspect 55: The method of Aspect 65, wherein the limit on the amount of data that can be adjusted to the second LCH relates to a maximum data size over a duration.

Aspect 56: The method of any of Aspects 46-55, further comprising: scheduling the SDU for transmission via the UL-SCH resources in accordance with an LCH prioritization restriction associated with the second LCH.

Aspect 57: The method of any of Aspects 46-56, further comprising: adjusting a scheduling eligibility state variable associated with an original LCH associated with SDU based at least in part on transmitting the SDU.

Aspect 58: The method of any of Aspects 46-57, further comprising: transmitting a BSR based at least in part on the second priority associated with the second LCH being higher than one or more priorities associated with one or more LCHs that have buffered data.

Aspect 59: The method of Aspect 58, further comprising: transmitting an SR triggered by the BSR in accordance with an SR configuration associated with the second LCH.

Aspect 60: A method of wireless communication performed at a network node, comprising: sending a configuration associated with priority adjustment associated with a first LCH having a first priority; and obtaining an SDU via UL-SCH resources in accordance with a second priority associated with a second LCH.

Aspect 61: The method of Aspect 60, wherein the configuration indicates whether the data assigned to the first LCH is allowed to be adjusted to the second LCH.

Aspect 62: The method of any of Aspects 60-61, wherein the configuration indicates a threshold associated with a remaining time of data in the first LCH.

Aspect 63: The method of any of Aspects 60-62, wherein the configuration indicates the second LCH.

Aspect 64: The method of any of Aspects 60-63, wherein the configuration indicates a maximum number of times that the data associated with the first LCH can be adjusted.

Aspect 65: The method of any of Aspects 60-64, wherein the configuration indicates a limit on an amount of data associated with the first LCH that can be adjusted to the second LCH.

Aspect 66: The method of Aspect 65, wherein the limit on the amount of data that can be adjusted to the second LCH relates to a maximum data size over a duration.

Aspect 67: The method of any of Aspects 60-66, further comprising: obtaining a BSR based at least in part on the second priority associated with the second LCH being higher than one or more priorities associated with one or more LCHs that have buffered data.

Aspect 68: The method of Aspect 67, further comprising: obtaining an SR triggered by the BSR in accordance with an SR configuration associated with the second LCH.

Aspect 69: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-68.

Aspect 70: An apparatus for wireless communication at a device, the apparatus comprising one or more memories and one or more processors coupled to the one or more memories, the one or more processors configured to cause the device to perform the method of one or more of Aspects 1-68.

Aspect 71: An apparatus for wireless communication, the apparatus comprising at least one means for performing the method of one or more of Aspects 1-68.

Aspect 72: A non-transitory computer-readable medium storing code for wireless communication, the code comprising instructions executable by one or more processors to perform the method of one or more of Aspects 1-68.

Aspect 73: A non-transitory computer-readable medium storing a set of instructions for wireless communication, the set of instructions comprising one or more instructions that, when executed by one or more processors of a device, cause the device to perform the method of one or more of Aspects 1-68.

Aspect 74: A device for wireless communication, the device comprising a processing system that includes one or more processors and one or more memories coupled with the one or more processors, the processing system configured to cause the device to perform the method of one or more of Aspects 1-68.

Aspect 75: An apparatus for wireless communication at a device, the apparatus comprising one or more memories and one or more processors coupled to the one or more memories, the one or more processors individually or collectively configured to cause the device to perform the method of one or more of Aspects 1-68.

Aspect 76: An apparatus for wireless communication at a device, comprising: a processing system that includes processor circuitry and memory circuitry that stores code and is coupled with the processor circuitry, the processing system configured to cause the device to perform the method of one or more of Aspects 1-68.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
receive a configuration associated with a logical channel (LCH) with a first priority, wherein the configuration indicates one or more parameters to adjust data assigned to the LCH from the first priority to a second priority;
adjust a priority of a service data unit (SDU) associated with the LCH to the second priority in accordance with the one or more parameters; and
transmit the SDU via uplink shared channel (UL-SCH) resources based at least in part on the second priority.

2. The apparatus of claim 1, wherein the configuration indicates whether the data assigned to the LCH is allowed to be adjusted to the second priority.

3. The apparatus of claim 1, wherein the configuration indicates a threshold associated with a remaining time of data in the LCH.

4. The apparatus of claim 3, wherein to adjust the priority of the SDU, the one or more processors are configured to cause the UE to:
adjust the priority of the SDU to the second priority in accordance with a determination that the SDU has a remaining time that satisfies the threshold.

5. The apparatus of claim 4, wherein the remaining time associated with the SDU is a residual value of a packet data convergence protocol (PDCP) discard timer associated with the SDU.

6. The apparatus of claim 1, wherein the configuration indicates the second priority.

7. The apparatus of claim 1, wherein the configuration indicates a maximum number of times that the data associated with the LCH can be adjusted.

8. The apparatus of claim 7, wherein to adjust the priority of the SDU, the one or more processors are configured to cause the UE to:
adjust the priority of the SDU to the second priority in accordance with a determination that data associated with the LCH has been adjusted to the second priority a number of times that is less than the maximum number of times.

9. The apparatus of claim 1, wherein the configuration indicates a limit on an amount of data associated with the LCH that can be adjusted to the second priority.

10. The apparatus of claim 9, wherein the limit on the amount of data that can be adjusted to the second priority relates to a maximum data size over a duration.

11. The apparatus of claim 1, wherein the one or more processors are configured to cause the UE to:
schedule the SDU for transmission via the UL-SCH resources in accordance with an LCH prioritization restriction associated with the second priority.

12. The apparatus of claim 1, wherein the one or more processors are configured to cause the UE to:
adjust a scheduling eligibility state variable associated with an original priority associated with the SDU based at least in part on transmission of the SDU.

13. The apparatus of claim 1, wherein the one or more processors are configured to cause the UE to:
transmit a buffer status report (BSR) based at least in part on a determination that the second priority is higher than one or more priorities associated with one or more LCHs that have buffered data.

14. The apparatus of claim 13, wherein the one or more processors are configured to cause the UE to:
transmit a scheduling request (SR) triggered by the BSR in accordance with an SR configuration associated with the second priority.

15. An apparatus for wireless communication at a network node, comprising:
one or more memories; and
one or more processors coupled with the one or more memories and configured to cause the network node to:
send a configuration associated with priority adjustment associated with a logical channel (LCH) with a first priority, wherein the configuration indicates one or more parameters to adjust data assigned to the LCH from the first priority to a second priority; and
obtain a service data unit (SDU) via uplink shared channel (UL-SCH) resources in accordance with the second priority.

16. An apparatus for wireless communication at a user equipment (UE), comprising:
one or more memories; and
one or more processors coupled with the one or more memories and configured to cause the UE to:
receive a configuration associated with a first logical channel (LCH) with a first priority, wherein the configuration indicates one or more priority adjustment parameters for data assigned to the first LCH;
adjust a service data unit (SDU) associated with the first LCH to a second LCH with a second priority in accordance with the one or more priority adjustment parameters; and
transmit the SDU via uplink shared channel (UL-SCH) resources based at least in part on the second priority associated with the second LCH.

17. The apparatus of claim 16, wherein the configuration indicates whether the data assigned to the first LCH is allowed to be adjusted to the second LCH, a threshold associated with a remaining time of data in the first LCH, the second LCH, a maximum number of times that the data associated with the first LCH can be adjusted, a limit on an amount of data associated with the first LCH that can be adjusted to the second LCH, or a combination thereof.

18. The apparatus of claim 16, wherein the one or more processors are configured to cause the UE to:
schedule the SDU for transmission via the UL-SCH resources in accordance with an LCH prioritization restriction associated with the second LCH.

19. The apparatus of claim 16, wherein the one or more processors are configured to cause the UE to:
adjust a scheduling eligibility state variable associated with an original LCH associated with the SDU based at least in part on transmission of the SDU.

20. The apparatus of claim 16, wherein the one or more processors are configured to cause the UE to:
transmit a buffer status report (BSR) based at least in part on a determination that the second priority associated with the second LCH is higher than one or more priorities associated with one or more LCHs that have buffered data.
